(19) United States
(12) Patent Application Publication
(10) Pub. No.: US 2023/0067567 A1
(43) Pub. Date: Mar. 2, 2023

(54) METHOD AND APPARATUS FOR OPERATING A MEASUREMENT RESOURCE IN A WIRELESS COMMUNICATION SYSTEM

(71) Applicant: LG ELECTRONICS INC., Seoul (KR)

(72) Inventor: Soo Jin KIM, Seoul (KR)

(73) Assignee: LG ELECTRONICS INC., Seoul (KR)

(21) Appl. No.: 17/445,302

(22) Filed: Aug. 17, 2021

(51) Int. Cl. H04W 24/08; H04W 24/10; H04L 5/14

(52) U.S. Cl. CPC H04W 24/08; H04W 24/10; H04L 5/14

(57) ABSTRACT

According to the present disclosure, a method for performing, by a user equipment, measurement report in a wireless communication system may include: receiving, by the user equipment, a measurement resource from a base station; performing measurement based on the measurement resource; and, transmitting a measurement report including a measurement result to the base station based on a result of the performing. Herein, the measurement report may include the measurement result and information indicating whether self-interference cancellation is successful.

### BACKGROUND OF THE INVENTION

### Field of the Invention

The present invention relates to a wireless communication system, and more particularly, to a method and apparatus for operating a resource for measurement in a full duplex radio (FDR) environment.

### Description of the Related Art

A wireless communication system refers to a multiple access system supporting communication with multiple users by sharing available system resources (e.g., bandwidth, transmit power, etc.). Examples of the multiple access system include a code division multiple access (CDMA) system, frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

Sidelink (SL) refers to a communication method of establishing a direct link between user equipments (UEs) and directly exchanging voice or data between the UEs without a base station (BS). SL is being considered as a method of solving the burden of the base station according to rapidly increasing data traffic.

In addition, the base station may allocate resources for uplink signals or resources for downlink signals to the UE or a vehicle. The base station may allocate the resources for the uplink signals to the UE or the vehicle through uplink control information (UCI) or allocate the resources for the downlink signals to the UE or the vehicle through downlink control information (DCI).

Meanwhile, as more communication devices require larger communication capacity, there is a need for improved mobile broadband communication as compared to existing radio access technology (RAT). Therefore, a communication system considering a service or UE sensitive to reliability and latency is being discussed. Next-generation radio access technology considering massive machine type communication (MTC) or ultra-reliable and low latency communication (URLLC) may be referred to as new radio access technology (RAT) or new radio (NR).

### SUMMARY

The present disclosure relates to a method and apparatus for operating a measurement resource by considering an FDR environment in a wireless communication system.

The present disclosure relates to a method and apparatus for operating a measurement resource based on self-interference signal control, when a user equipment simultaneously performs transmission and reception in a single frequency transmission band based on FDR in a wireless communication system.

The present disclosure relates to a method and apparatus for operating a measurement resource based on self-interference signal control, when a user equipment performs handover based on radio link failure (RLF) in a wireless communication system.

The present disclosure relates to a method and apparatus for operating a measurement resource based on self-interference signal control, when a user equipment operates a measurement resource based on beam failure recovery (BFR) in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method for performing, by a user equipment, measurement report in a wireless communication system may include: receiving, by the user equipment, a measurement resource from a base station; executing measurement based on the measurement resource; and, transmitting a measurement report including a measurement result to the base station based on a result of execution. Herein, the measurement report may include the measurement result and information indicating whether self-interference cancellation is successful.

Also, as an example of the present disclosure, a user equipment configured to perform measurement report in a wireless communication system includes a transceiver and a processor coupled to the transceiver. The processor is configured to receive a measurement resource from a base station via the transceiver, to execute measurement based on the measurement resource, and to transmit a measurement report including a measurement result to the base station based on a result of execution. The measurement report may include, along with the measurement result, information indicating whether self-interference cancellation is successful.

Also, as an example of the present disclosure, a method for receiving, by a base station, a measurement report in a wireless communication system may include transmitting, by a user equipment, a measurement resource and receiving the measurement report including a result of measurement executed by the user equipment. The measurement report may include information indicating whether self-interference cancellation is successful.

In addition, the following aspects may commonly apply.

As an example of the present disclosure, a user equipment may operate based on at least one of full duplex radio (FDR) and half duplex radio (HDR).

Also, as an example of the present disclosure, in case a user equipment performs communication with a base station based on FDR, the user equipment may simultaneously perform uplink signal transmission and downlink signal reception in a single frequency band.

Also, an example of the present disclosure, a user equipment performing communication with a base station based on FDR may execute a self-interference cancellation operation in order to receive a downlink signal.

Also, as an example of the present disclosure, in case information indicating whether self-interference cancellation is successful indicates success of self-interference cancellation, a base station may execute at least one of a handover procedure and a beam recovery procedure based on a measurement report.

Also, as an example of the present disclosure, in case information indicating whether self-interference cancellation is successful indicates failure of self-interference cancellation, a base station may change configuration information for a user equipment and retransmit a measurement resource to the user equipment based on the changed configuration information.

Also, as an example of the present disclosure, configuration information may include at least one of transmission power control information, duplex mode change information and resource re-allocation information.

Also, as an example of the present disclosure, a measurement resource may include at least one of a channel status information-reference signal (CSI-RS) and a synchronization signal block (SSB).

Also, as an example of the present disclosure, a user equipment may perform measurement through a measurement resource based on at least one among received signal received power (RSRP), reference signal received quality (RSRQ), and signal to interference plus noise ratio (SINR).

Also, as an example of the present disclosure, a measurement report may include information on at least one of RSRP, RSRQ and SINR and information regarding whether self-interference cancellation is successful.

Also, as an example of the present disclosure, information regarding whether self-interference cancellation is successful may be configured by one-bit information.

The above-described aspects of the present disclosure are only a part of the preferred embodiments of the present disclosure, and various embodiments reflecting technical features of the present disclosure may be derived and understood by those skilled in the art on the basis of the detailed description of the present disclosure provided below.

The following effects may be produced by embodiments based on the present disclosure.

According to the present disclosure, a method for operating a measurement resource by considering an FDR environment in a wireless communication system may be provided.

According to the present disclosure, a method for operating a measurement resource based on self-interference signal control, when a user equipment simultaneously performs transmission and reception in a single frequency transmission band based on FDR in a wireless communication system, may be provided.

According to the present disclosure, a method for operating a measurement resource based on self-interference signal control, when a user equipment performs handover based on radio link failure (RLF) in a wireless communication system, may be provided.

According to the present disclosure, a method for operating a measurement resource based on self-interference signal control, when a user equipment operates a measurement resource based on beam failure recovery (BFR) in a wireless communication system, may be provided.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 illustrates the structure of a wireless communication system according to an embodiment of the present disclosure.

FIG. 2 illustrates the structure of a radio frame of NR according to an embodiment of the present disclosure.

FIG. 3 illustrates the structure of a self-contained slot according to an embodiment of the present disclosure.

FIG. 4 illustrates the concept of a user equipment (UE) and a base station supporting full duplex radio (FDR) according to an embodiment of the present disclosure.

FIG. 5 illustrates an example of transmit/receive link and self-interference in a FDR communication situation according to an embodiment of the present disclosure.

FIG. 6 illustrates a position, to which three interference techniques at a radio frequency (RF) front end is applied, according to an embodiment of the present disclosure.

FIG. 7 illustrates the structure of a transceiver for self-interference cancellation in a communication device according to an embodiment of the present disclosure.

FIG. 8 is a view illustrating a method for performing a handover procedure based on HDR according to an embodiment of the present disclosure.

FIG. 9 is a view illustrating a method for operating a measurement resource, when a base station recognizes a user equipment's failure in self-interference cancellation in a full duplex resource region before the user equipment receives the measurement resource, according to an embodiment of the present disclosure.

FIG. 10 is a view illustrating a method for operating a measurement resource, when a base station recognizes a user equipment's failure in self-interference cancellation in a full duplex resource region before the user equipment receives the measurement resource and transmits a measurement report, according to an embodiment of the present disclosure.

FIG. 11 is a view illustrating a method for operating a measurement resource, when a base station recognizes a user equipment's failure in self-interference cancellation in a full duplex resource region after the user equipment receives a handover command, according to an embodiment of the present disclosure.

FIG. 12 is a view illustrating a method for performing, by a user equipment, handover in a specific period, when the user equipment fails in self-interference cancellation based on FDR, according to an embodiment of the present disclosure.

FIG. 13 is a view illustrating a method for selecting a measurement resource by considering a case in which a user equipment succeeds in self-interference cancellation of a measurement resource, according to an embodiment of the present disclosure.

FIG. 14 is a view illustrating a method for transmitting a measurement report by including information on a self-interference cancellation result for a measurement resource in the measurement report, according to an embodiment of the present disclosure.

FIG. 15 is a flowchart illustrating a method for operating, by a user equipment, a measurement resource, according to an embodiment of the present disclosure.

FIG. 16 is a flowchart illustrating a method for operating, by a base station, a measurement resource, according to an embodiment of the present disclosure.

FIG. 17 illustrates an example of a communication system according to an embodiment of the present disclosure.

FIG. 18 illustrates an example of a wireless device according to an embodiment of the present disclosure.

FIG. 19 illustrates a circuit of processing a transmission signal according to an embodiment of the present disclosure.

FIG. 20 illustrates another example of a wireless device according to an embodiment of the present disclosure.

FIG. 21 illustrates an example of a portable device according to an embodiment of the present disclosure.

FIG. 22 illustrates an example of a vehicle or an autonomous vehicle according to an embodiment of the present disclosure.

### DETAILED DESCRIPTION

The following embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment.

In the description of the drawings, procedures or steps which render the scope of the present invention unnecessarily ambiguous will be omitted and procedures or steps which can be understood by those skilled in the art will be omitted.

In the entire specification, when a certain portion “comprises” or “includes” a certain component, this indicates that the other components are not excluded, but may be further included unless specially described. The terms “unit”, “-or/er” and “module” described in the specification indicate a unit for processing at least one function or operation, which may be implemented by hardware, software and a combination thereof. In addition, “a or an”, “one”, “the” and similar related words may be used as the sense of including both a singular representation and a plural representation unless it is indicated in the context describing the present specification (especially in the context of the following claims) to be different from this specification or is clearly contradicted by the context.

In the present specification, “A or B” may mean “only A”, “only B” or “both A and B”. In other words, in the present specification, “A or B” may be interpreted as “A and/or B”. For example, in the present specification, “A, B or C” may mean “only A, “only B”, “only C” or “any combination of A, B and C”.

A slash (/) or comma used in the present specification may mean “and/or”. For example, “A/B” may mean “A and/or B”. Therefore, “A/B” may mean “only A”, “only B” or “both A and B”. For example, “A, B, C” may mean “A, B or C”.

In the present specification, “at least one of A and B” may mean “only A”, “only B” or “both A and B”. In addition, in the specification, “at least one of A or B” or “at least one of A and/or B” may be interpreted as being the same as “at least one of A and B”.

In addition, in the present specification, “at least one of A, B and C” may mean “only A”, “only B”, “only C” or “any combination of A, B and C”. In addition, in the specification, “at least one of A, B or C” or “at least one of A, B and/or C” may be interpreted as being the same as “at least one of A, B and C”.

In addition, parentheses used in the present specification may mean “for example”. Specifically, when “control information (PDCCH)” is described, “PDCCH” may be proposed as an example of “control information”. In other words, “control information” of the present specification is not limited to “PDCCH” and “PDCCH” may be proposed as an example of “control information”. In addition, even when “control information (that is, PDCCH)” is described, “PDCCH” may be proposed as an example of “control information”.

In the following description, “when, if or in case of” may be replaced with “based on”.

In this specification, technical features individually described in one drawing may be implemented individually or simultaneously.

In this specification, a higher layer parameter may be set for a user equipment (UE), preset or predefined. For example, a base station or a network may transmit a higher layer parameter to a UE. For example, the higher layer parameter may be transmitted through radio resource control (RRC) signaling or medium access control (MAC) signaling.

The following technology can be applied to various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc. IEEE 802.16m is an evolution of IEEE 802.16e and provides backward compatibility with a system based on IEEE 802.16e. UTRA is a part of Universal Mobile Telecommunications System (UMTS). Third generation partnership project (3GPP) long term evolution (LTE) is a part of Evolved UMTS (E-UMTS) using E-UTRA, adopting OFDMA for DL and SC-FDMA for UL. LTE-Advanced (LTE-A) is an evolution of 3GPP LTE.

5G NR is subsequent technology of LTE-A and is a new clean-state mobile communication system having features such as high performance, low latency and high availability. 5G NR may utilize all available spectral resources such as low frequency bands of less than 1 GHz to intermediate frequency bands of 1 GHz to 10 GHz or high frequency (millimeter) bands of 24 GHz or higher.

5G NR is focused upon in order to clarify the description but the technical idea of an embodiment of the present disclosure is not limited thereto.

For terms and technologies which are not specifically described among terms and technologies used in this specification, reference may be made to the wireless communication standard document published before application of this specification. For example, 3GPP TS36.XXX, 3GPP TS37.XXX and 3GPP38.XXX documents may be referenced.

### Communication System Applicable to the Present Disclosure

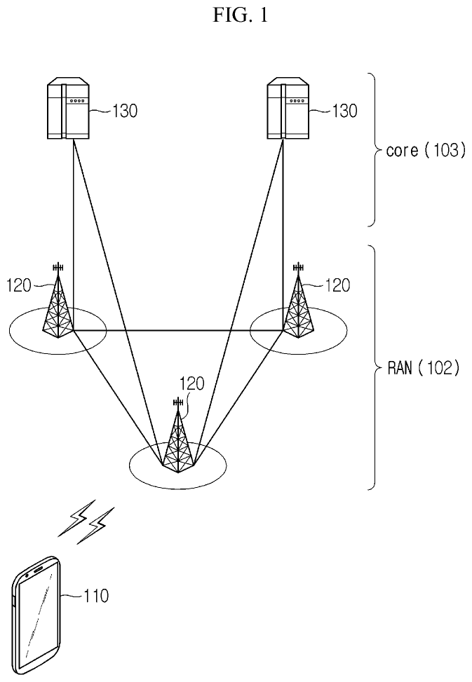

FIG. 1 illustrates the structure of a wireless communication system according to an embodiment of the present disclosure. The embodiment of FIG. 1 may be combined with various embodiments of the present disclosure.

Referring to FIG. 1, the wireless communication system includes a radio access network (RAN) 102 and a core network 103. The RAN 102 includes a base station 120 for providing a user equipment 110 with a control plane and a user plane. The user equipment 110 may be fixed or mobile and may be referred to as the other term such as user equipment (UE), mobile station (MS), subscriber station (SS), mobile subscriber station (MSS), mobile user equipment or advanced mobile station (AMS), wireless device or the like. The base station 120 is a node for providing a radio access service to the user equipment 110 and may be referred to as the other term such as a fixed station, a Node B, a eNode B (eNB), a gNode B (gNB), a ng-eNB, an advanced base station (ABS) or an access point (AP), a base transceiver system (BTS), or the like. The core network 103 includes a core network entity 130. The core network entity 103 may be variously defined according to the function and may be referred to as the other term such as a core node, a network node, a network equipment or the like.

The structural elements of the system may be referred to differently according to the applied system standard. In the case of LTE or LTE-A, the RAN 102 is an Evolved-UMTS Terrestrial Radio Access Network (E-UTRAN), and the core network 103 may be referred to as an evolved packet core (EPC). In this case, the core network 103 includes a mobility management entity (MME), a serving gateway (S-GW) and a packet data network-gateway (P-GW). The MME has access information of the user equipment or information on the capabilities of the user equipment, and such information is mainly used for mobility management of the user equipment. The S-GW is a gateway with an E-UTRAN as an end point, and the P-GW is a gateway having a packet data network (PDN) as an end point.

In the case of the 5G NR standard, the RAN 102 is a NG-RAN, and the core network 103 may be referred to as a 5G core (5GC). In this case, the core network 103 includes an access and mobility management function (AMF), a user plane function (UPF), and a session management function (SMF). The AMF provides a function for access and mobility management of a user equipment unit, the UPF performs a function for mutually transferring a data unit between a higher layer network and the RAN 102, and the SMF provides a session management function.

The base stations 120 may be connected to each other through an Xn interface. The base station 120 may be connected to the core network 103 through an NG interface. More specifically, the base station 120 may be connected to the AMF through an NG-C interface, and may be connected to the UPF through an NG-U interface.

### Radio Resource Structure

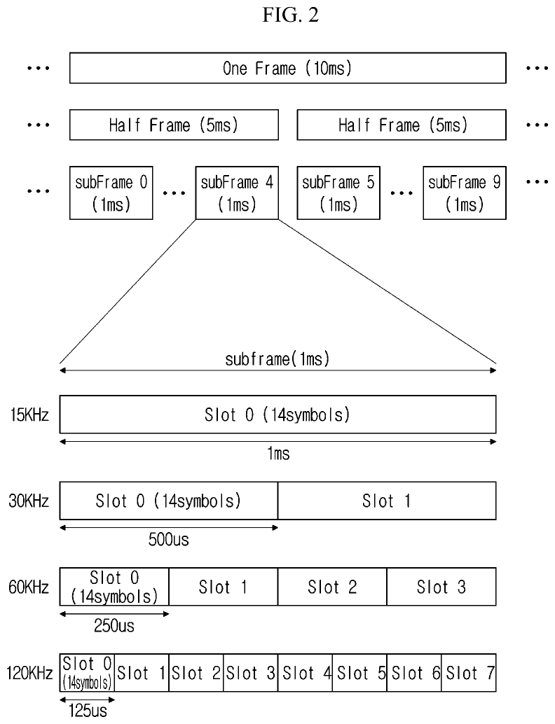

FIG. 2 illustrates the structure of a radio frame of NR according to an embodiment of the present disclosure. The embodiment of FIG. 2 may be combined with various embodiments of the present disclosure.

Referring to FIG. 2, in NR, a radio frame may be used in uplink and downlink transmission. A radio frame has a length of 10 ms and may be defined as two 5-ms half-frames (HFs). The half-frame includes five 1-ms subframes (SFs). The subframe may be divided into one or more slots and the number of slots in the subframe may be determined according to a subscriber spacing (SCS). Each slot may include 12 or 14 OFDM(A) symbols according to a cyclic prefix (CP).

When a normal CP is used, each slot may include 14 symbols. When an extended CP is used, each slot may include 12 symbols. Here, the symbol may include an OFDM symbol (or a CP-OFDM symbol) and an SC-FDMA (Single Carrier-FDMA) symbol (or a DFT-s-OFDM (Discrete Fourier Transform-spread-OFDM) symbol).

When the normal CP is used, the number N^{slot}_{symb} of symbols per slot, the number N^{frame,u}ₛₗₒₜ of slots per frame and the number N^{subframe,u}ₛₗₒₜ of slots per subframe may vary according to the SCS configuration (u). For example, SCS(=15*2^{μ}), N^{slot}_{symb}, N^{frame,μ}ₛₗₒₜ, and N^{subframe,u}ₛₗₒₜ may be 15 KHz, 14, 10 and 1 in the case of u=0, may be 30 KHz, 14, 20 and 2 in the case of u=1, may be 60 KHz, 14, 40, 4 in the case of u=2, may be 120 KHz, 14, 80 and 8 in the case of u=3, and may be 240 KHz, 14, 160, 16 in the case of u=4. In contrast, when the extended CP is used, SCS(=15*2^{μ}), N^{slot}_{symb}, N^{frame,μ}ₛₗₒₜ, and N^{subframe,μ}ₛₗₒₜ may be 60 KHz, 12, 40 and 4 in the case of u=2. In the NR system, an OFDM(A) numerology (e.g., SCS, CP length, etc.) may be differently set among a plurality of cells merged into one user equipment. Accordingly, the (absolute time) duration of time resources (e.g., a subframe, a slot or a TTI) (for convenience, collectively referred to as a time unit (TU)) consisting the same number of symbols may be differently set between merged cells.

In NR, a plurality of numerologies or SCS supporting various 5G services may be supported. For example, a wide area in typical cellular bands may be supported when SCS is 15 kHz, and dense-urban, lower latency and wider carrier bandwidth may be supported when SCS is 30 kHz/60kHz. When SCS is 60 kHz or higher, bandwidth greater than 24.25 GHz may be supported in order to overcome phase noise.

The NR frequency band may be defined as two types of frequency ranges. The two types of frequency ranges may be FR1 and FR2. The numerical value of the frequency range may be changed and, for example, frequency ranges corresponding to FR1 and FR2 may be 450 MHz to 6000 MHz and 24250 MHz to 52600 MHz. In addition, the supported SCS may be 15, 30 and 60 kHz in the case of FR1, and may be 60, 120 and 240 kHz in the case of FR2. Among the frequency ranges used in the NR system, FR1 may mean “sub 6 GHz range”, and FR2 may mean “above 6 GHz range” and may be called as millimeter wave (mmW).

As described above, the numerical value of the frequency range of the NR system may be changed. For example, as compared to the above-described example of the frequency range, FR1 may be defined as including a band of 410 MHz to 7125 MHz. That is, FR1 may include a frequency band of 6 GHz (or 5850, 5900, 5925 MHz, etc.) or higher. For example, a frequency band of 6 GHz (or 5850, 5900, 5925 MHz, etc.) included in FR1 may include an unlicensed band. The unlicensed band may be used for various purposes and may be used, for example, for vehicle communication (e.g., autonomous driving).

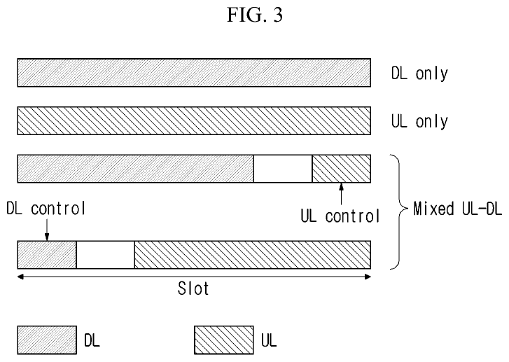

FIG. 3 illustrates the structure of a self-contained slot according to an embodiment of the present disclosure.

In the NR system, a frame is characterized by a self-contained structure in which a DL control channel, DL or UL data, a UL control channel, etc. may all be included in one slot. For example, the first N symbols in the slot may be used to transmit a DL control channel (hereinafter referred to as a DL control region) and the last M symbols in the slot may be used to transmit a UL control channel (hereinafter referred to as a UL control region). N and M are integers of 0 or more. A resource region (hereinafter referred to as a data region) between a DL control region and a UL control region may be used for DL data transmission or UL data transmission. For example, the following configurations may be considered. Durations was listed in chronological order.

1. DL only configuration

2. UL only configuration

3. Mixed UL-DL configuration

DL region+GP (Guard Period)+UL control region

DL control region+GP+UL region

DL region: (i) DL data region, (ii) DL control region+DL data region

UL region: (i) UL data region, (ii) UL data region+UL control region

A PDCCH may be transmitted in the DL control region and a PDSCH may be transmitted in the DL data region. A PUCCH may be transmitted in the UL control region and a PUSCH may be transmitted in the UL data region. In the PDCCH, DCI (Downlink Control Information), for example, DL data scheduling information, UL data scheduling information, etc. may be transmitted. In the PUCCH, UCI, for example, ACK/NACK (Positive Acknowledgement/Negative Acknowledgement) information related to DL data, CSI (Channel State Information) information, SR (Scheduling Request), etc. may be transmitted. The GP provides a time gap in a process of switching a transmission mode to a reception mode or switching from a reception mode to a transmission mode in a base station (BS) and a UE. Some symbols at a point in time when DL is switched to UL within the subframe may be set as a GP.

### Overview of FDR System and Interference Element in FDR

The FDR system enables simultaneous transmission and reception of uplink and downlink signals on the same frequency band. Accordingly, the FDR system may increase spectral efficiency up to two times that of the existing system for transmitting and receiving uplink and downlink signals by dividing a frequency or time and thus is being spotlighted as one of the core technologies of a next-generation mobile communication system.

From the viewpoint of any wireless device, an FDR technology using a single frequency transmission band may be defined as a transmission resource configuration method of simultaneously performing transmission and reception through a single frequency transmission band. As a special example thereof, the FDR technology may be represented as a transmission resource configuration method of simultaneously performing, for wireless communication between a general access node (e.g., a base station, a repeater, a relay node, a remote radio head (RRH), etc.) and a wireless user equipment, downlink transmission and uplink reception of the base station and downlink reception and uplink transmission of the wireless UE through a single frequency transmission band. As another example, the FDR technology may be represented as a transmission resource configuration method of simultaneously performing transmission and reception between wireless UEs in the same frequency transmission band in a situation of device-to-device direct communication (D2D) between wireless UEs.

Hereinafter, although the present disclosure describes proposed technologies related to FDR such as wireless transmission and reception between a general base station and a wireless UE, various proposed embodiments are applicable to a network wireless device for performing wireless transmission and reception with a UE other than a general base station and direct UE-to-UE communication between UEs.

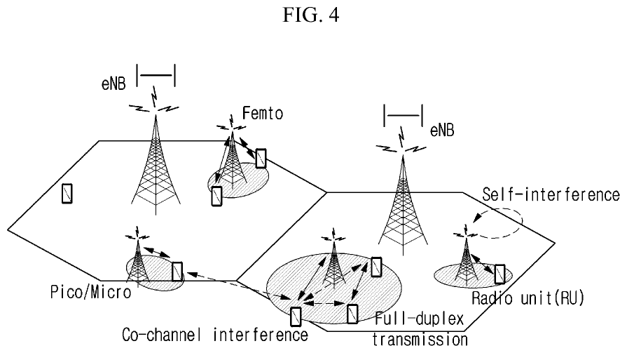

FIG. 4 illustrates the concept of a user equipment (UE) and a base station supporting full duplex radio (FDR) according to an embodiment of the present disclosure. In the FDR situation shown in FIG. 4, there may be a total of three types of interference as follows.

Intra-device self-interference: Since transmission and reception are performed using the same time and frequency resources, a device simultaneously receives not only a desired signal but also a signal transmitted by the device. In this case, the signal transmitted by the device is received by a receive antenna of the device with little attenuation and thus is received with much greater power than the desired signal, thereby acting as interference.

UE to UE inter-link interference: This means that an uplink signal transmitted by a UE is received by an adjacent UE, thereby acting as interference.

BS to BS inter-link interference: This means that a signal transmitted between BSs or heterogenous base stations (e.g., a picocell, a femtocell or a relay node) in a HetNet situation is received by a receive antenna of another base station, thereby acting as interference.

Among the above three types of interference, intra-device self-interference (SI) occurs only in the FDR system. The SI greatly degrades performance of the FDR system, which is treated as a first problem to be solved in order to operate the FDR system.

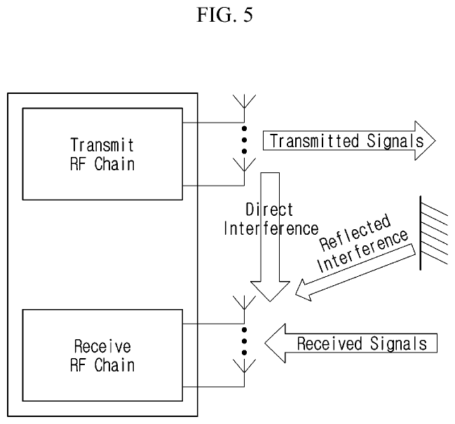

FIG. 5 illustrates an example of transmit/receive link and self-interference in a FDR communication situation according to an embodiment of the present disclosure.

As shown in FIG. 5, SI may be classified into direct interference in which a signal transmitted by a transmit antenna directly enters a receive antenna without path attenuation and reflected interference reflected by a surrounding terrain. The intensity of the direct interference and the reflected interference is generally greater than that of the desired signal because of a difference in physical distance. Due to such a large intensity of interference, effective cancellation of SI is essential for operating the FDR system.

In order to efficiently operate the FDR system, requirements of self-interference cancellation (self-IC) according to maximum transmit power may be determined as shown in Table 1 below.

TABLE 1

| | | Thermal | | Receiver | Self-IC |
|---|---|---|---|---|---|
| | Max. Tx | Noise | | Thermal | Target |
| | Power | (BW = | Receiver | Noise | (P_{A}-TN- |
| Node Type | (P_{A}) | 20 MHz) | NF | Level | NF) |
| Macro eNB | 46 dBm | −101 dBm | 5 dB (for | −96 dBm | 142 dB |
| | | | eNB) | | |
| Pico eNB | 30 dBm | | | | 126 dB |
| Femto eNB, | 23 dBm | | | | 119 dB |
| WLAN AP | | | | | |
| UE | 23 dBm | | 9 dB (for | −92 dBm | 115 dB |
| | | | UE) | | |

According to the bandwidth of a mobile communication system, a thermal noise value may be determined by N_{0,BW}=−174 dBm+10×log₁₀(BW), and Table 1 shows thermal noise on the assumption of bandwidth of 20 MHz. A receiver noise figure (NF) is an example of considering the worst case of the 3GPP standard requirements. A receiver thermal noise level may be determined by a sum of thermal noise in specific BW and receiver NF.

Referring to Table 1, it can be seen that self-interference cancellation performance of 119 dBm is required in order for a UE to efficiently drive the FDR system in bandwidth of 20 MHz. In order to obtain such self-interference cancellation performance, there are a total of three steps of self-interference cancellation techniques, which will be described below in detail.

antenna self-IC: This is a technique to be preferentially executed among all self-interference cancellation techniques, and SI cancellation is performed at an antenna end. As a simplest way, a material capable of blocking signals between transmit and receive antennas may be installed to physically block transmission of an SI signal, a distance between antennas may be intendedly controlled using multiple antennas or the phase of a specific transmitted signal may be inverted to cancel some SI signals. In addition, some SI signals may be canceled using a multi-polarized antenna or a directional antenna.

analog self-IC: This is a technique that cancels interference at an analog end before a received signal passes through an analog-to-digital converter (ADC) and cancels SI signals using a duplicated analog signal. This may be performed in an RF domain or an IF domain.

A method of cancelling an SI signal will be described below in detail. A transmitted analog signal is delayed in time and then a duplicated signal of the actually received SI signal may be generated by adjusting a magnitude and a phase thereof, and subtracted from a signal received by a receive antenna. However, since processing is performed using the analog signal, additional distortion may occur due to implementation complexity and circuit characteristics, thereby greatly changing interference cancellation performance.

digital self-IC: This is a technique that cancels interference after a received signal passes through an ADC and includes all interference cancellation techniques performed in a baseband domain. As a simplest way, a duplicated signal of SI may be generated using a transmitted digital signal and subtracted from a received digital signal. Alternatively, techniques for preventing a signal transmitted by a UE or a base station from being received by a receive antenna by performing precoding/postcoding in the baseband using multiple antennas may also be classified as digital self-interference cancellation.

However, since digital self-interference cancellation is feasible when a digitally modulated signal is quantized enough to restore information on a desired signal, there is a need for a precondition that a difference in signal power level between an interference signal remaining after cancelling interference using one or more of the above-described techniques and the desired signals is within an ADC range.

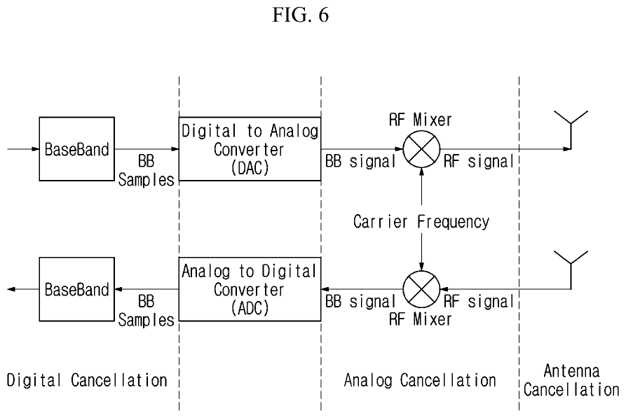

Positions, to which the above-described three self-interference cancellation techniques are applied, are shown in FIG. 6. FIG. 6 illustrates positions, to which three interference techniques at a radio frequency (RF) front end is applied, according to an embodiment of the present disclosure. Referring to FIG. 6, antenna cancellation for performing antenna self-interference cancellation is applied to an antenna section, analog cancellation for performing analog self-interference cancellation is applied to a section including a mixer for converting a baseband signal into an RF signal, and digital cancellation for performing digital self-interference cancellation is applied to a section before digital-to-analog converter (DAC) input and after ADC output.

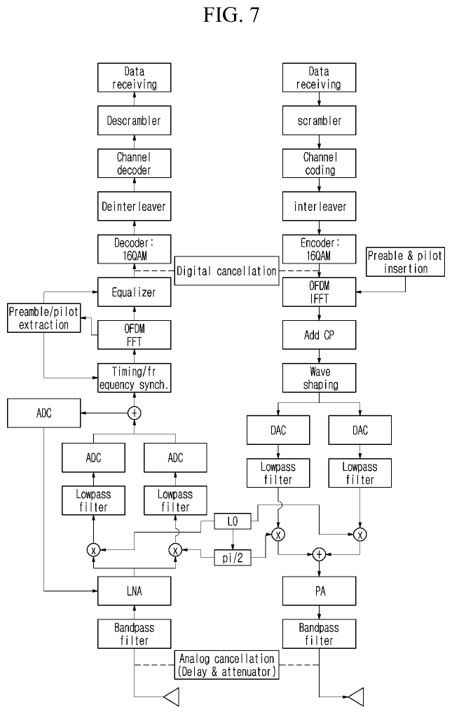

FIG. 7 illustrates the structure of a transceiver for self-interference cancellation in a communication device according to an embodiment of the present disclosure. In FIG. 7, a digital cancellation block for performing digital self-interference cancellation performs interference cancellation using digital self-interference signal (digital SI) before the DAC and after passing through the ADC. However, in another example, digital self-interference cancellation may be performed using a digital self-interference signal after passing through an IFFT and before passing through an FFT. In addition, although FIG. 7 shows a structure for canceling a self-interference signal by separating a transmit antenna and a receiver antenna, an antenna interference cancellation technique using one antenna may be used in another example. In this case, the antenna structure may be different from the example of FIG. 7. To this end, a function block suitable for a purpose may be further added or deleted.

### Signal Modeling of FDR System

The FDR system uses the same frequency between the transmitted signal and the received signal and thus are greatly affected by non-linear components in RF. In particular, the transmitted signal may be distorted by the non-linear characteristics of active elements such as the power amplifier of a transmit RF chain and a low noise amplifier (LNA) of a receive RF chain, and distortion may also be caused by a mixer in the transmit and receive RF chains. Due to such distortion, the transmitted signal may be modeled as generating a high-order component. Among them, an even-order component is generated around direct current (DC) and in a high frequency region corresponding to several times a center frequency and thus may be efficiently removed using an existing alternative current (AC) coupling or filtering technique. However, an odd-order component is generated adjacent to an existing center frequency and is not easily removed, unlike the even-order component, thereby having great influence upon reception. In consideration of the non-linear characteristics of the odd-order component, the received signal after the ADC in the FDR system is expressed using a parallel Hammerstein (PH) model as shown in Equation 1 below.

$$y ( n ) = {h}_{D} ( n ) * {x}_{D} ( n ) + {\sum }_{{k = 1 , … , K}_{k = odd}} {h}_{SI , k} ( n ) * {\vert {x}_{SI} ( n ) \vert}^{k - 1} {x}_{SI} ( n ) + z ( n ) , \qquad [ Equation 1 ]$$

In Equation 1, y(n) denotes a received signal, h_{D}(n) denotes a channel experienced by desired data, x_{D}(n) denotes desired data to be received, h_{SI,k}(n) denotes a self-channel experienced by transmitted data, x_{SI}(n) denotes transmitted data, and z(n) denotes additive white gaussian noise (AWGN). h_{SI,k}(n) is a linear component when k is 1 and is a non-linear component when k is an odd number of 3 or more.

In order to cancel the above-described analog or digital self-interference, it is necessary to estimate a self-channel. In this case, a received signal after performing self-interference cancellation using gain of the estimated analog or digital self-channel may be expressed as shown in Equation 2 below.

$${y}_{Self - IC} ( n ) = {h}_{D} ( n ) * {x}_{D} ( n ) + {\underbrace{\begin{matrix}{\sum }_{{k = 1 , … , K}_{k = odd}} & ( {h}_{SI , k} ( n ) - {\hat{h}}_{SI , k} ( n ) ) * {\vert {x}_{SI} ( n ) \vert}^{k - 1} {x}_{SI} ( n )\end{matrix}}}_{Residual SI} + z ( n ) , \qquad [ Equation 2 ]$$

In Equation 2, y_{Self-IC}(n) denotes a received signal after interference cancellation, h_{D}(n) denotes a channel experienced by desired data, x_{D}(n) denotes desired data to be received, h_{SI,k}(n) denotes a self-channel experienced by transmitted data, ĥ_{SI,k}(n) denotes gain of the estimated analog or digital self-channel, x_{SI}(n) denotes transmitted data, and z(n) denotes AWGN.

Thereafter, a result of decoding the received signal using the gain of the estimated desired channel is shown in Equation 3 below.

$$\begin{matrix}\frac{{\hat{h}}_{D}^{*} ( n ) {y}_{Self - IC} ( n )}{{\vert {\hat{h}}_{D}^{*} ( n ) \vert}^{2}} = \frac{{\hat{h}}_{D}^{*} ( n ) * {h}_{D} ( n )}{{\vert {\hat{h}}_{D}^{*} ( n ) \vert}^{2}} {x}_{D} ( n ) + \frac{{\hat{h}}_{D}^{*} ( n ) * {z}^{′} ( n )}{{\vert {\hat{h}}_{D}^{*} ( n ) \vert}^{2}} \\ = {x}_{D} ( n ) + \frac{{\hat{h}}_{D}^{*} ( n ) * e ( n )}{{\vert {\hat{h}}_{D}^{*} ( n ) \vert}^{2}} + \frac{{\hat{h}}_{D}^{*} ( n ) * {z}^{′} ( n )}{{\vert {\hat{h}}_{D}^{*} ( n ) \vert}^{2}}\end{matrix} \qquad [ Equation 3 ]$$

$${z}^{′} ( n ) = {\sum }_{{k = 1 , … , K}_{k = odd}} ( {h}_{SI , k} ( n ) - {\hat{h}}_{SI , k} ( n ) ) * {\vert {x}_{SI} ( n ) \vert}^{k - 1} {x}_{SI} ( n ) + z ( n )$$

$$e ( n ) = {h}_{D} ( n ) - {\hat{h}}_{D} ( n )$$

In Equation 3, ĥ_{D}(n) denotes an estimated desired channel, y_{Self-IC}(n) denotes a received signal after interference cancellation, h_{D}(n) denotes a channel experienced by desired data, x_{D}(n) denotes desired data to be received, h_{SI,k}(n) denotes a self-channel experienced by transmitted data, ĥ_{SI,k}(n) denotes gain of the estimated analog or digital self-channel, x_{SI}(n) denotes transmitted data, and z(n) denotes AWGN.

### Detailed Embodiments of the Present Invention

Hereinafter will be described a method in which a user equipment operating based on FDR performs measurement report. As an example, measurement report of a user equipment may be performed based on either radio link failure (RLF) or beam failure recovery (BFR). As a concrete example, a user equipment may detect RLF. That is, the user equipment may detect that a received signal of a link in connection is lowered below a preset level. Herein, the user equipment may perform measurement to execute handover to another cell. As an example, the user equipment may receive a measurement resource from a base station, perform measurement based on the received measurement resource and report a measurement result to the base station.

As another example, a user equipment may detect beam failure. That is, the user equipment may detect that reception strength for a connected beam is lowered below a preset level. Herein, the user equipment may perform measurement to identify a candidate beam with good quality. As an example, the user equipment may receive a measurement resource corresponding to each beam and perform measurement based on the received measurement resource. Then, the user equipment may a measurement result to a base station, and a beam may be newly selected based on the measurement result. That is, the user equipment may receive a measurement resource based on RLF or BFR, but is not limited thereto.

Herein, in case a user equipment operating based on an FDR mode performs measurement report, the user equipment may confirm a measurement resource and transmit a measurement report to a base station based on the measurement resource. Herein, the user equipment may perform a handover procedure or a beam recovery procedure based on the transmission of the measurement resource and the measurement report, which is the same as described above. Herein, as whether the handover procedure or the beam recovery procedure is to be performed may be determined based on the measurement report, reliability for measurement resource reception and measurement report operation may need to be ensured in the user equipment. Accordingly, in a user equipment operating based on an FDR mode requiring self-interference cancellation, it may need to be determined, regarding a measurement procedure, whether to operate in the FDR mode like data transmission and reception or to operate in HDR in consideration of ensuring reliability, and a method thereof will be described below.

Herein, as an example, a user equipment may receive a measurement resource from a base station and perform measurement report based on the measurement resource. At this time, the measurement resource may include at least one of a channel status information-reference signal (CSI-RS) and a synchronization signal block (SSB) based on beam control. Herein, the measurement report may be performed based on the measurement resource. As an example, based on CSI-RS, a measurement report may include at least one among measurement results per CSI-RS resource, measurement results per cell based on CSI-RS resource(s), and CSI-RS resource measurement identifiers.

As another example, based on SSB, a measurement report may include at least one among measurement results per SSB resource, measurement results per cell based on SSB resource(s), and SSB resource measurement identifiers, but is not limited to the above-described embodiment.

In addition, as an example, triggering for a measuring procedure may be applied when RLF occurs and an RRC-connected user equipment performs handover based on radio link monitoring. As another example, triggering for a measuring procedure may be applied when BFR occurs and an RRC-connected user equipment performs a beam recovery procedure based on beam monitoring. As yet another example, a measuring procedure may be performed based on Table 2 below, and triggering may not be limited to a specific type.

TABLE 2
Event A1 (Serving becomes better than threshold)
Event A2 (Serving becomes worse than threshold)
Event A3 (Neighbor becomes offset better than SpCell)
Event A4 (Neighbor becomes better than threshold)
Event A5 (SpCell becomes worse than threshold1 and neighbor becomes
better than threshold2)
Event A6 (Neighbor becomes offset better than SCell)
Event B1 (Inter RAT neighbor becomes better than threshold)
Event B2 (PCell becomes worse than threshold1 and inter RAT neighbor
becomes better than threshold2)
Event I1 (Interference becomes higher than threshold)
Event C1 (The NR sidelink channel busy ratio is above a threshold)
Event C2 (The NR sidelink channel busy ratio is below a threshold)

In addition, as an example, when a user equipment performs measurement based on a measurement resource, the user equipment may perform measurement based on at least one among received signal received power (RSRP), reference signal received quality (RSRQ), and signal to interference plus noise ratio (SINR) and may report information thereon as a measurement result. That is, the user equipment may report a measurement result after performing measurement based on a measurement resource and is not limited to a specific type. Hereinafter, for the convenience of explanation, a user equipment will be described based on a procedure of receiving a measurement resource and reporting a measurement result base on handover, but may not be limited thereto. That is, the methods below may be equally applied to a case in which a user equipment receives a measurement resource and reports a measurement result to a base station through measurement in a BFR procedure or any other procedure, but may not be limited to a specific type.

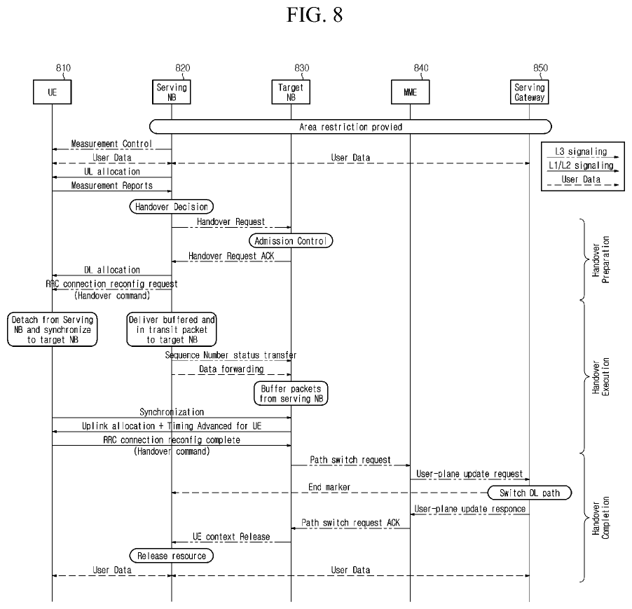

FIG. 8 is a view illustrating a method for performing a handover procedure based on HDR according to an embodiment of the present disclosure.

As an example, referring to FIG. 8, a user equipment 810 may be a user equipment that operates based on an HDR mode. That is, the user equipment 810 may be a user equipment that does not simultaneously transmit and receive a signal based on one frequency band. Herein, in case the user equipment 810 moves from a serving NB 820 of a cell, in which communication is being currently performed, to a target NB 830 of another cell, the user equipment 810 may perform a handover procedure that enables communication without interruption while retaining transmitted and received data in current use.

As an example, the user equipment 810 may transmit to an RRC-connected state by performing RRC connection with the serving NB 820. Herein, when the user equipment 810 performs RRC connection with the serving NB 820, the serving NB 820 may transfer information, which requests to report the strength of a received signal, to the user equipment 810 through a measurement control message. As an example, a measurement control message may include information on Table 2 described above and is not limited to a specific embodiment. Also, the measurement control message may be transferred through an RRC configuration message or an RRC connection reconfiguration message based on a case in which the serving NB 820 and the user equipment 810 perform RRC connection.

Herein, the user equipment 810 may measure the strength of a received signal in a serving cell and neighboring cells and may transfer a measurement report message to a base station when a specific event occurs. Thus, the serving NB 820 may obtain received, from the user equipment 810, signal strength information of the serving cell and the neighboring cells. Then, the serving NB 820 may determine whether to execute handover by referring to the signal strength information reported by the user equipment 810 and state information of the cells and may execute handover to a target cell. Herein, a handover preparation step may be a step in which the serving NB 820 and the target NB 830 carry out preparation for handover of the user equipment 810. As an example, the serving NB 820 may transfer a UE context to the target NB 830 and check whether the target NB 830 is capable of providing a service to the user equipment 810. Herein, when the target NB 830 is capable of providing the service to the user equipment 810, the target NB 830 may set a transport bearer for packet forwarding. In addition, the target NB 830 may allocate a C-RNTI value used by the user equipment 810 accessing the target NB 830 and may transfer the C-RNTI value to the serving NB 820. Then, the user equipment 810 may complete preparation for performing handover by obtaining C-RNTI information from the serving NB 820.

Herein, as an example, a resource for packet forwarding between the serving NB 820 and the target NB 830 may be allocated. When a resource for a new user equipment is allocated from the target NB 830 and preparation for supporting handover is completed, the serving NB 820 may transfer a handover command message to the user equipment 810 and the user equipment 810 may execute handover based on a handover command.

Herein, a handover execution step may be a step in which the user equipment 810 actually executes handover. As an example, the user equipment 810 may access a new cell by disconnecting a link to the serving NB 820 and setting a link to the target NB 830. Next, in the handover execution step, the user equipment 810 may quickly access the target NB 830 through C-RNTI, which the target NB 830 allocates in the handover preparation step, so that handover may be executed. Herein, a DL packet, in which the handover is executed, may be transferred from the serving NB 820 to the target NB 830 through a forwarding bearer. Thus, as the DL packet may be buffered in the target NB 830 until the user equipment 810 completes access to the target NB 830, packet loss may be prevented. In addition, a UL packet occurring in the user equipment 810 may be suspended until the user equipment 810 completes access to the target NB 830. When the user equipment 810 completes access to the target NB 830, the user equipment 810 may transmit the UL packet to the target NB 830.

In addition, as an example, a handover completion step may be a step in which, after the user equipment 810 successfully completes access to the target NB 830, an access path of the user equipment 810 is changed to the target NB 830. Herein, the forwarding bearer, which forwarded the DL packet in the handover execution step, may be released when the access change is completed. As an example, the access path change of the user equipment 810 may be performed based on a mobility management entity (MME) 840 and a serving gateway 850. In addition, as an example, in a new communication system, the access path change of the user equipment 810 may be performed based on an access & mobility management function (AMF), a user plane function (UPF) and a session management function (SMF), but is not limited to the above-described embodiment. While a handover procedure is implemented based on what is described above, a user equipment may receive a measurement resource from a base station, perform measurement for a received signal and report a measurement result to the base station.

Herein, as an example, a user equipment operating based on an FDR mode may simultaneously transmit and receive a signal in a single frequency band by performing self-interference signal cancellation as described above. However, in case the user equipment fails in self-interference signal cancellation, a method for controlling, by a base station, the operation of the user equipment may be needed. As an example, a hybrid automatic repeat and request (HARQ procedure operation may be set between a user equipment operating based on an FDR mode and a base station. Herein, the user equipment operating based on the FDR mode may feed NACK back to the base station by distinguishing decoding failure of a DL signal due to channel quality or other cell/UE interference and failure of self-interference signal control. As an example, in case NACK is fed back to a base station in a HARQ procedure, a user equipment may indicate a cause of failure to a base station through a flag so that the operation of a user equipment based on an FDR mode may be efficiently implemented. As another example, when decoding according to the performance of self-interference control fails based on a user equipment's failure of self-interference, operation may be performed by limiting report time.

Herein, like in the above-described handover procedure, in case a user equipment receives a measurement resource, performs measurement and reports a measurement result to a base station, it may be necessary to control a user equipment operating based on an FDR mode. Specifically, in case a user equipment operating based on an FDR mode fails in self-interference cancellation, a result of measurement (e.g. RSRP/RSRQ/SINR etc) of a user equipment, which becomes a criterion for whether or not to execute handover for a user equipment, may not be reliable. Accordingly, unnecessary handover may be executed, or handover may not be executed even when it is necessary. In consideration of what is described above, a base station and a user equipment may control measurement resource operation for a user equipment operating based on an FDR mode, which will be described below. In addition, as an example, for the convenience of explanation, the description below is presented based on handover, but is not limited thereto. That is, when measurement is needed in a user equipment operating based on an FDR mode, a user equipment and a base station may control measurement resource operation in order to ensure reliability of measurement, and the same may be applied to a case in which measurement is needed.

As a concrete example, a user equipment, which simultaneously receives and transmits a signal based on an FDR mode, may operate a measurement resource in an HDR mode. That is, in order to reduce the effect of self-interference and improve measurement reliability, a measurement resource may be operated based on an HDR mode.

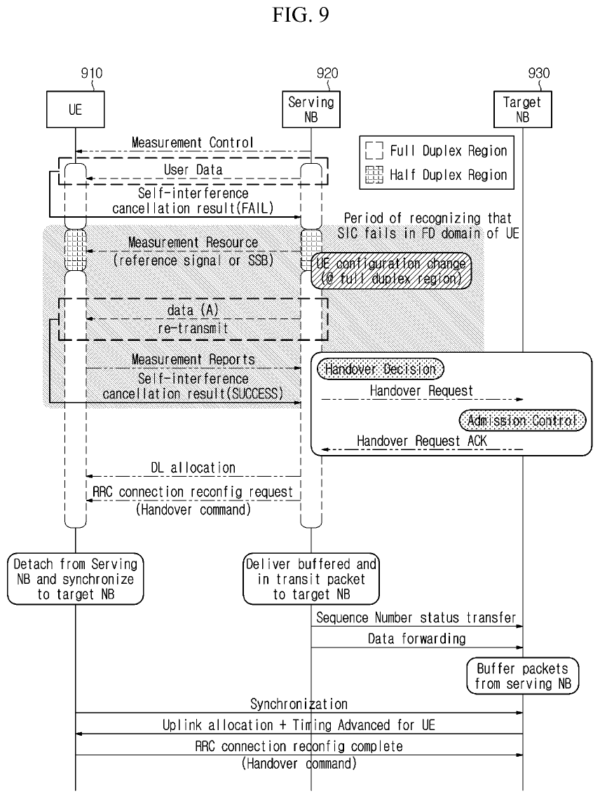

FIG. 9 is a view illustrating a method for operating a measurement resource, when a base station recognizes a user equipment's failure in self-interference cancellation in a full duplex resource region before the user equipment receives the measurement resource, according to an embodiment of the present disclosure. Referring to FIG. 9, a user equipment 910 may simultaneously receive and transmit data from and to a serving NB 920 based on an FDR mode. Herein, in order to improve reliability of measurement, the serving NB 920 may operate a measurement resource based on an HDR mode. As an example, as described above, a measurement resource may be at least one of CSI-RS and SSB and is not limited to a specific embodiment. That is, when the serving NB 920 transmits a measurement resource to the user equipment 910, the measurement resource may be transmitted to the user equipment 910 through a single frequency band operating only as a downlink, and self-interference cancellation may not be needed in the frequency band. As the user equipment 910 receives data based on an FDR mode, self-interference cancellation may be performed in relation to the data. Herein, the user equipment 910 may perform self-interference cancellation and feed information on a result back to the serving NB 920. Before the serving NB 920 transmits a measurement resource to the user equipment 910, the user equipment 910 may fail in self-interference cancellation and transmit information on the failure of self-interference cancellation to the serving NB 920. As a more concrete example, the serving NB 920 may receive data-related NACK from the user equipment 910 based on a HARQ procedure and may recognize, through a flag of NACK, that data decoding failure is caused by the failure of self-interference cancellation. Herein, when the serving NB 920 receives self-interference cancellation information from the user equipment 910, the serving NB 920 may change UE configuration information (e.g. Tx Power control/duplex mode change/resource re-allocation) of the user equipment related to an FDR mode and may retransmit data based on the changed user equipment configuration information. Herein, as an example, a measurement resource may be transmitted based on an HDR mode. That is, the user equipment 910 may receive a measurement resource, irrespective of self-interference cancellation, perform measurement and transmit a measurement result to the serving NB 920. That is, since the measurement resource may be transmitted to the user equipment based on the HDR mode in a frequency band operating only as a downlink, the measurement resource may be irrelevant to whether or not self-interference cancellation is successful. Accordingly, the serving NB 920 may utilize measurement result information based on the FDR mode, irrespective of whether or not the user equipment 910 has succeeded in self-interference cancellation. Next, as in FIG. 8, the serving NB 920 may execute handover to the target NB 930 based on the measurement result information. Herein, as an example, an uplink/downlink resource of a serving cell, which is used in the handover procedure, may be operated in an HDR mode or FDR mode and may not be limited to a specific embodiment.

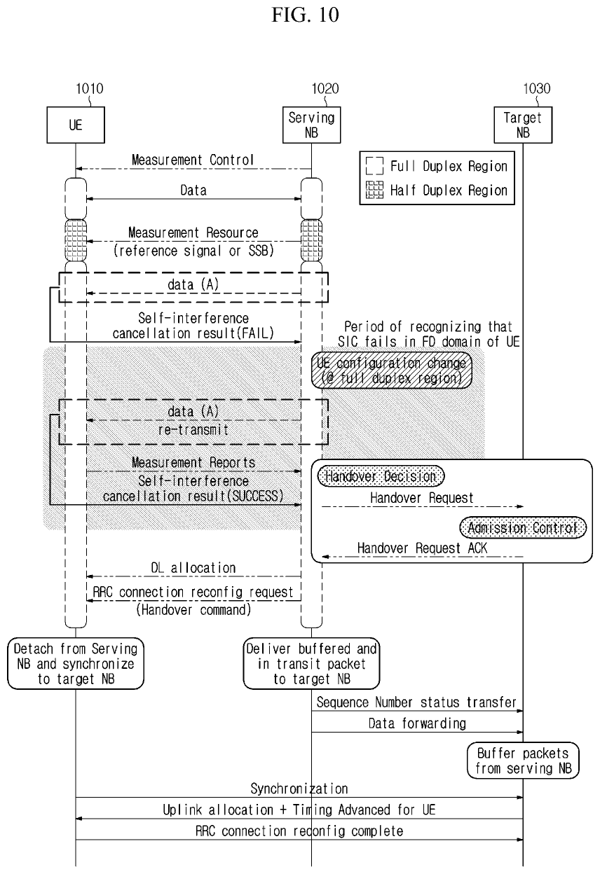

FIG. 10 is a view illustrating a method for operating a measurement resource, when a base station recognizes a user equipment's failure in self-interference cancellation in a full duplex resource region before the user equipment receives the measurement resource and transmits a measurement report, according to an embodiment of the present disclosure.

Referring to FIG. 10, a user equipment 1010 may simultaneously receive and transmit data from and to a serving NB 1020 based on an FDR mode. Herein, in order to improve reliability of measurement, the serving NB 1020 may operate a measurement resource based on an HDR mode. As an example, as described above, a measurement resource may be at least one of CSI-RS and SSB and is not limited to a specific embodiment. That is, when the serving NB 1020 transmits a measurement resource to the user equipment 1010, the measurement resource may be transmitted to the user equipment 1010 through a single frequency band operating only as a downlink, and self-interference cancellation may not be needed in the frequency band. Herein, as an example, as the user equipment 1010 receives data based on an FDR mode, self-interference cancellation may be performed in relation to the data. Herein, the user equipment 1010 may perform self-interference cancellation and feed information on a result back to the serving NB 1020.

As an example, after the serving NB 1020 transmits a measurement resource to the user equipment 1010, the user equipment 1010 may fail in self-interference cancellation and transmit information on the failure of self-interference cancellation to the serving NB 1020. As a more concrete example, the serving NB 1020 may receive data-related NACK from the user equipment 1010 based on a HARQ procedure and may recognize, through a flag of NACK, that data decoding failure is caused by the failure of self-interference cancellation. Herein, when the serving NB 1020 receives self-interference cancellation information from the user equipment 1010, the serving NB 1020 may change UE configuration information (e.g. Tx Power control/duplex mode change/resource re-allocation) of the user equipment related to an FDR mode and may retransmit data based on the changed user equipment configuration information. Herein, as an example, a measurement resource may be transmitted based on an HDR mode. That is, the user equipment 1010 may receive a measurement resource, irrespective of self-interference cancellation, perform measurement and transmit a measurement result to the serving NB 1020. Accordingly, the serving NB 1020 may utilize measurement result information based on the FDR mode, irrespective of whether or not the user equipment 1010 has succeeded in self-interference cancellation. That is, as in FIG. 8, the serving NB 1020 may execute handover to the target NB 1030 based on the measurement result information. Herein, as an example, an uplink/downlink resource of a serving cell, which is used in the handover procedure, may be operated in an HDR mode or FDR mode and may not be limited to a specific embodiment.

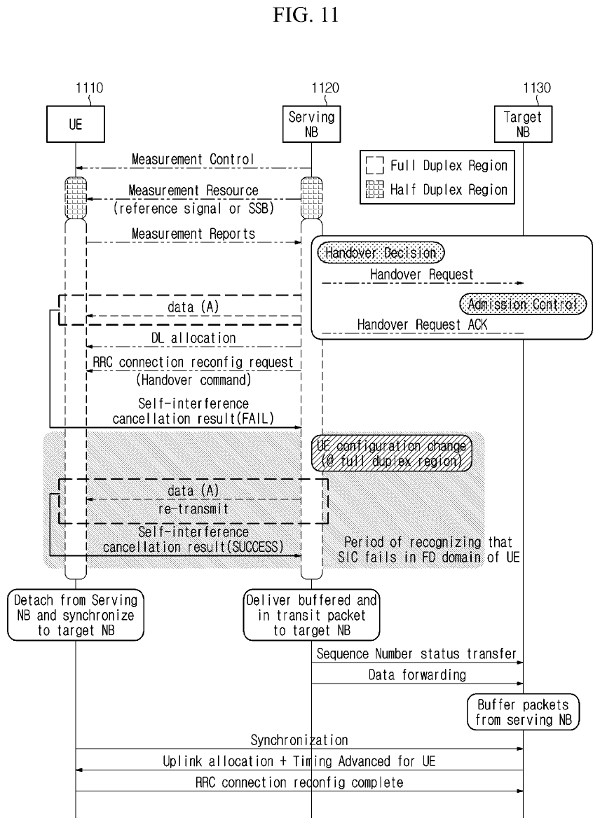

FIG. 11 is a view illustrating a method for operating a measurement resource, when a base station recognizes a user equipment's failure in self-interference cancellation in a full duplex resource region after the user equipment receives a handover command, according to an embodiment of the present disclosure.

Referring to FIG. 11, a user equipment 1110 may simultaneously receive and transmit data from and to a serving NB 1120 based on an FDR mode. Herein, in order to improve reliability of measurement, the serving NB 1120 may operate a measurement resource based on an HDR mode. As an example, as described above, a measurement resource may be at least one of CSI-RS and SSB and is not limited to a specific embodiment. That is, when the serving NB 1120 transmits a measurement resource to the user equipment 1110, the measurement resource may be transmitted to the user equipment 1110 through a single frequency band operating only as a downlink, and self-interference cancellation may not be needed in the frequency band. Herein, as an example, as the user equipment 1110 receives data based on an FDR mode, self-interference cancellation may be performed in relation to the data. Herein, the user equipment 1110 may perform self-interference cancellation and feed information on a result back to the serving NB 1120.

As an example, after the serving NB 1120 transmits a measurement resource to the user equipment 1110, receives a measurement result and transmits a handover command to the user equipment 1110, the user equipment 1110 may fail in self-interference cancellation and transmit information on the failure of self-interference cancellation to the serving NB 1120. As a more concrete example, the serving NB 1120 may receive data-related NACK from the user equipment 1110 based on a HARQ procedure and may recognize, through a flag of NACK, that data decoding failure is caused by the failure of self-interference cancellation. Herein, when the serving NB 1120 receives self-interference cancellation information from the user equipment 1110, the serving NB 1120 may change UE configuration information (e.g. Tx Power control/duplex mode change/resource re-allocation) of the user equipment related to an FDR mode and may retransmit data based on the changed user equipment configuration information. Herein, as an example, a measurement resource may be transmitted based on an HDR mode. That is, the user equipment 1110 may receive a measurement resource, irrespective of self-interference cancellation, perform measurement and transmit a measurement result to the serving NB 1120. Accordingly, the serving NB 1120 may utilize measurement result information based on the FDR mode, irrespective of whether or not the user equipment 1110 has succeeded in self-interference cancellation. That is, as in FIG. 8, the serving NB 1120 may execute handover to the target NB 1130 based on the measurement result information. Herein, as an example, an uplink/downlink resource of a serving cell, which is used in the handover procedure, may be operated in an HDR mode or FDR mode and may not be limited to a specific embodiment.

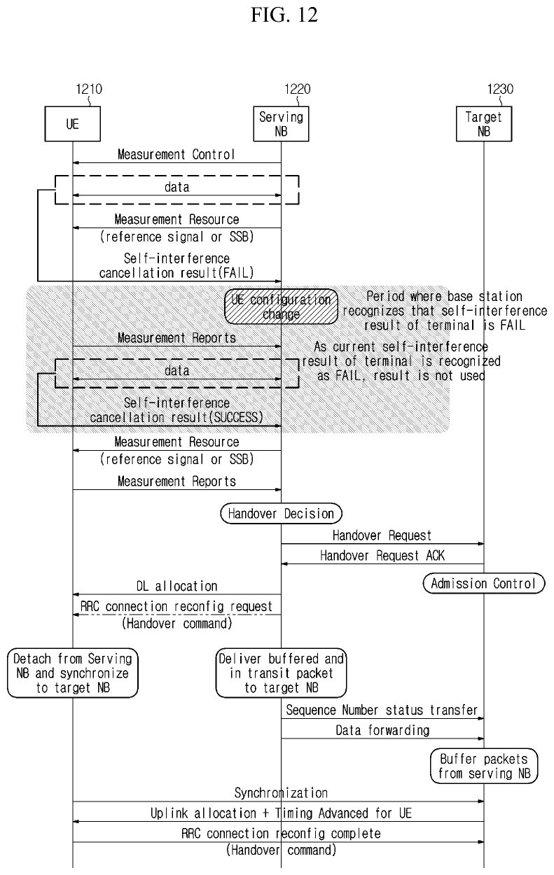

FIG. 12 is a view illustrating a method for performing, by a user equipment, handover in a specific period, when the user equipment fails in self-interference cancellation based on FDR, according to an embodiment of the present disclosure. As an example, based on FIGS. 9 to 11 described above, when a measurement resource is operated based on an HDR mode, as a base station should operate a DL resource both in an FDR mode and in the HDR mode, a procedure of allocating a resource may become complicated. As an example, in consideration of what is described above, a measurement resource may also be operated based on an FDR mode.

As an example, as described above, a measurement resource may be at least one of CSI-RS and SSB and is not limited to a specific embodiment. Herein, the measurement resource may also be operated based on an FDR mode at the same time as the transmittance of another uplink signal. As a concrete example, in FIG. 12, a user equipment 1210 may fail in self-interference cancellation and feed self-interference cancellation failure information back to a serving NB 1220, and a detailed feedback method is the same as described above.

In addition, the serving NB 1220 may change user equipment configuration information based on the self-interference failure information, which is the same as described above. Herein, when the user equipment 1210 receives a measurement resource before feeding the self-interference cancellation failure information back to the serving NB 1220, the user equipment 1210 may perform measurement through the measurement resource and transmit a measurement result to the serving NB 1220. However, as described above, since the measurement resource is operated based on the FDR mode and the user equipment 1210 feeds self-interference cancellation failure information to the serving NB 1220, the reliability of measurement result of the user equipment 1210 may not be ensured. That is, since the user equipment 1210 performs measurement without canceling self-interference and feeds result information back to the serving NB 1220, the information may not be considered as normal feedback information. Accordingly, the serving NB 1220 may ignore the measurement result information. As another example, the serving NB 1220 may decode but not use the measurement result information. Next, the serving NB 1220 may change user equipment configuration information (e.g. Tx Power control/duplex mode change/resource re-allocation) for normal operation and apply the changed user equipment configuration information to FDR mode transmission. Next, the serving NB 1220 may retransmit data to the user equipment 1210, and the user equipment 1210 may execute self-interference cancellation based on the retransmitted data and feed the result back to the serving NB 1220. Herein, before receiving feedback of self-interference cancellation success information, the serving NB 1220 may ignore measurement result report information, as described above. Next, when receiving feedback of self-interference cancellation success information, the serving NB 1220 may transmit the measurement resource to the user equipment 1210 and receive feedback of measurement result information that is measured by the user equipment 1210. Next, the serving NB 1220 may perform a handover procedure of the user equipment 1210 to the target NB 1230.

As another example, when the serving NB 1220 operates a measurement resource based on an FDR mode likewise in another procedure (e.g. beam recovery procedure), the serving NB 1220 may transfer the measurement resource after obtaining, from the user equipment 1210, information on whether or not self-interference cancellation is successful and receive a measurement result report. Thus, reliability of the measurement resource may be ensured.

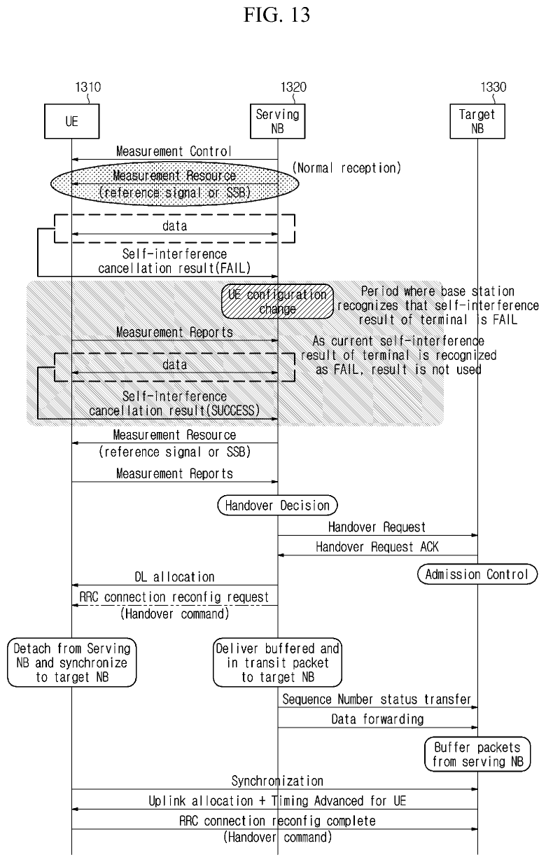

FIG. 13 is a view illustrating a method for selecting a measurement resource by considering a case in which a user equipment succeeds in self-interference cancellation of a measurement resource, according to an embodiment of the present disclosure.

As an example, based on FIGS. 9 to 11 described above, when a measurement resource is operated based on an HDR mode, as a base station should operate a DL resource both in an FDR mode and in the HDR mode, a procedure of allocating a resource may become complicated. As an example, in consideration of what is described above, a measurement resource may also be operated based on an FDR mode.

As an example, as described above, a measurement resource may be at least one of CSI-RS and SSB and is not limited to a specific embodiment. Herein, the measurement resource may also be operated based on an FDR mode at the same time as the transmittance of another uplink signal. As a concrete example, in FIG. 13, a user equipment 1310 may fail in self-interference cancellation and feed self-interference cancellation failure information back to a serving NB 1320, and a detailed feedback method is the same as described above. In addition, the serving NB 1320 may change user equipment configuration information (e.g. Tx Power control/duplex mode change/resource re-allocation) based on self-interference failure information, which is the same as described above. Herein, unlike FIG. 12, it is possible to consider a case in which the user equipment 1310 normally receives a measurement resource from the serving NB 1320 before feeding back the self-interference cancellation failure information. That is, it may be a case in which the user equipment 1310 normally receives a measurement resource. Herein, as an example, after the user equipment 1310 normally receives the measurement resource, self-interference failure may occur in relation to data reception. That is, the user equipment 1310 may succeed in self-interference cancellation for the measurement resource but fail in self-interference cancellation for the data subsequently transmitted. Herein, the user equipment 1310 should transmit a measurement result report to the serving NB 1320 as the user equipment 1310 successfully receives the measurement resource, but like in FIG. 12, the serving NB 1320 may recognize the self-interference failure of the user equipment 1310 and ignore the measurement report, thereby increasing handover execution time.

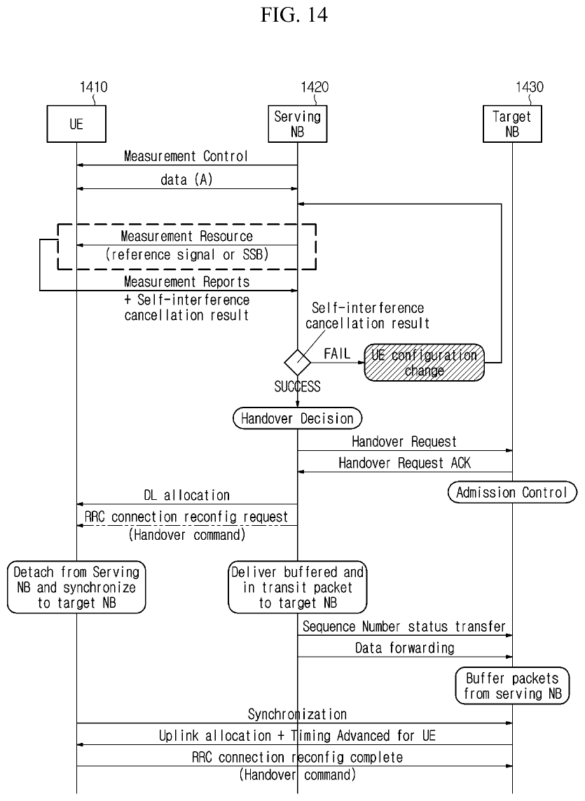

Referring to FIG. 14 in consideration of what is described above, a user equipment 1410 may transmit a measurement report by including self-interference cancellation result information for a measurement resource in the measurement report.

Specifically, in case the user equipment 1410 receives the measurement resource from the serving NB 1420, performs measurement and transmits a measurement report to the serving NB 1420, the measurement report may include information on self-interference cancellation result. That is, the serving NB 1420 may confirm, through the measurement report, whether or not the user equipment 1410 succeeds in self-interference cancellation. Herein, as an example, in case the measurement report indicates self-interference cancellation success, the serving NB 1420 may utilize other information included in the measurement report. That is, the serving NB 1420 may execute handover of the user equipment 1410 to the target NB 1430. As a concrete example, “Self-Interference-Cancel-Result”, which is a self-interference cancellation result, may be added to “MeasQquntityResults” among RRC messages for measurement report. As an example, “Self-Interference-Cancel-Result” may be one-bit information. If “Self-Interference-Cancel-Result” has a first value, it may indicate self-interference cancellation success. If it has a second value, it may indicate self-interference cancellation failure. However, the present disclosure may not be limited thereto.

TABLE 3
MeasQuantityResults ::= SEQUENCE {

| Self-Interference-Cancel-Result | ENUMERATED (SUCCESS, | |
|---|---|---|
| | FAIL) | |
| rsrp | RSRP-Range | OPTIONAL, |
| rsrq | RSRQ-Range | OPTIONAL, |
| sinr | SINR-Range | OPTIONAL |

}

On the other hand, the measurement report indicates self-interference cancellation failure, the serving NB 1420 may change user equipment configuration information (e.g. Tx Power control/duplex mode change/resource re-allocation) and retransmit the measurement resource to the user equipment 1410 based on the changed user equipment configuration information. As another example, when the serving NB 1420 operates a measurement resource based on an FDR mode likewise in another procedure (e.g. beam recovery procedure), self-interference cancellation failure information may be included in a measurement report, as described above, and be indicated to the serving NB 1420, which may not be limited to a handover procedure.

That is, FIGS. 9 to 14 have been described based on a handover procedure but are not limited thereto, and the same may apply to a case in which a user equipment receives a measurement resource, performs measurement and reports a measurement result to a base station.

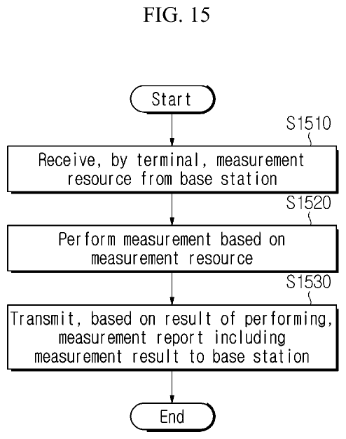

FIG. 15 is a flowchart illustrating a method for operating, by a user equipment, a measurement resource, according to an embodiment of the present disclosure.

Referring to FIG. 15, a user equipment may receive a measurement resource from a base station (S1510). Herein, as an example, the measurement resource may include at least one of CSI-RS and SSB. Herein, the user equipment may perform measurement through the measurement resource that is received based on at least one of RSRP, RSRQ and SINR (S1520). Next, the user equipment may transmit a measurement report, which includes information on at least one of RSRP, RSRQ and SINR, to the base station (S1530). Herein, as an example, the user equipment may operate based on at least one of FDR and HDR. As a concrete example, the user equipment may operate for every signal reception and transmission in at least one of FDR mode and HDR mode. As another example, the user equipment may determine in which mode between FDR mode and HDR mode each resource or each piece of information is to be transmitted. As an example, the user equipment and the base station may perform data transmission based on an FDR mode. On the other hand, for the measurement resource, the user equipment and the base station may operate based on an HDR mode in order to ensure measurement reliability, which may be the same as in FIGS. 9 to 11.

As another example, the user equipment may operate in the FDR mode also for the measurement resource but may not be limited to a specific embodiment. Herein, in case the user equipment performs communication with the base station based on FDR, the user equipment may simultaneously perform uplink signal transmission and downlink signal reception in a single frequency band. Herein, the user equipment performing communication with the base station based on FDR may execute a self-interference cancellation operation in order to receive a downlink signal.

As a concrete example, the user equipment may execute a self-interference cancellation operation and feed information on whether or not self-interference cancellation is successful back to the base station. Herein, as an example, the base station may process measurement report differently based on whether or not self-interference cancellation is successful. As an example, when the base station receives feedback indicating the failure of self-interference cancellation, the base station may ignore the received measurement result on the ground that reliability of the measurement report is not ensured. On the other hand, when the base station receives feedback indicating the success of self-interference cancellation, the base station may perform a handover procedure or a beam recovery procedure based on measurement report, which is not limited to the above-described embodiment.

As another example, a user equipment may transmit measurement report to a base station by including information on whether or not self-interference cancellation is successful in the measurement report. As an example, in order to enable the base station to recognize whether or not self-interference cancellation is successful while performing measurement report, information on whether or not self-interference cancellation is successful may be included in the measurement report, and thus the base station may immediately determine whether or not to ignore the measurement report. That is, in case information indicating whether or not self-interference cancellation is successful indicates success of self-interference cancellation, the base station may execute at least one of a handover procedure and a beam recovery procedure based on a measurement report. On the other hand, in case the information indicating whether or not self-interference cancellation is successful indicates failure of self-interference cancellation, the base station may change configuration information for the user equipment and retransmit the measurement resource to the user equipment based on the changed configuration information. As an example, configuration information may include at least one of transmission power control information, duplex mode change information and resource re-allocation information, which is the same as described above. As another example, information regarding whether or not self-interference cancellation is successful may be configured as one-bit information.

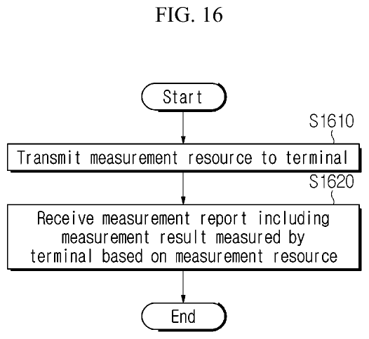

FIG. 16 is a flowchart illustrating a method for operating, by a base station, a measurement resource, according to an embodiment of the present disclosure.

Referring to FIG. 16, a user equipment may transmit a measurement resource to a base station (S1610). Herein, as an example, the measurement resource may include at least one of CSI-RS and SSB. Herein, the user equipment may perform measurement through the measurement resource that is received based on at least one of RSRP, RSRQ and SINR. Next, the user equipment may transmit a measurement report, which includes information on at least one of RSRP, RSRQ and SINR, to the base station. That is, the base station may receive the measurement report including a measurement result that is measured based on the measurement resource by the user equipment (S1620). Herein, as an example, the user equipment may operate based on at least one of FDR and HDR. As a concrete example, for every signal reception and transmission, the base station and the user equipment may operate in at least one of FDR mode and HDR mode. As another example, the base station and the user equipment may determine in which mode between FDR mode and HDR mode each resource or each piece of information is to be transmitted. As an example, the base station and the user equipment may perform data transmission based on an FDR mode. On the other hand, for the measurement resource, the base station and the user equipment may operate based on an HDR mode in order to ensure measurement reliability, which may be the same as in FIGS. 9 to 11.

As another example, the base station and the user equipment may operate in the FDR mode also for the measurement resource but may not be limited to a specific embodiment. Herein, in case the user equipment performs communication with the base station based on FDR, the user equipment may simultaneously perform uplink signal transmission and downlink signal reception in a single frequency band. Herein, the user equipment performing communication with the base station based on FDR may execute a self-interference cancellation operation in order to receive a downlink signal.

As a concrete example, the user equipment may execute a self-interference cancellation operation and feed information on whether or not self-interference cancellation is successful back to the base station. That is, the base station may receive, from the user equipment, information on whether or not self-interference cancellation is successful. Herein, as an example, the base station may process measurement report differently based on whether or not self-interference cancellation is successful. As an example, when the base station receives feedback indicating the failure of self-interference cancellation, the base station may ignore the received measurement result on the ground that reliability of the measurement report is not ensured. On the other hand, when the base station receives feedback indicating the success of self-interference cancellation, the base station may perform a handover procedure or a beam recovery procedure based on measurement report, which is not limited to the above-described embodiment.

As another example, a base station may receive, from a user equipment, a measurement report including information on whether or not self-interference cancellation is successful. As an example, in order to enable the base station to recognize whether or not self-interference cancellation is successful while performing measurement report, information on whether or not self-interference cancellation is successful may be included in the measurement report, and thus the base station may immediately determine whether or not to ignore the measurement report. That is, in case information indicating whether or not self-interference cancellation is successful indicates success of self-interference cancellation, the base station may execute at least one of a handover procedure and a beam recovery procedure based on a measurement report. On the other hand, in case the information indicating whether or not self-interference cancellation is successful indicates failure of self-interference cancellation, the base station may change configuration information for the user equipment and retransmit the measurement resource to the user equipment based on the changed configuration information. As an example, configuration information may include at least one of transmission power control information, duplex mode change information and resource re-allocation information, which is the same as described above. As another example, information regarding whether or not self-interference cancellation is successful may be configured as one-bit information.

### System and Various Devices, to which Embodiments of the Present Disclosure are Applicable

Various embodiments of the present disclosure may be combined with each other.

Hereinafter, a device, to which various embodiments of the present disclosure are applicable, will be described. Although not limited thereto, various descriptions, functions, procedures, proposes, methods and/or operation flowcharts disclosed in the present disclosure are applicable to various fields requiring wireless communication/connection (e.g., 5G) between devices.

Hereinafter, it will be described in greater detail with reference to the drawings. In the following drawings/description, the same reference numerals may denote the same or corresponding hardware blocks, software blocks or functional blocks unless otherwise stated.

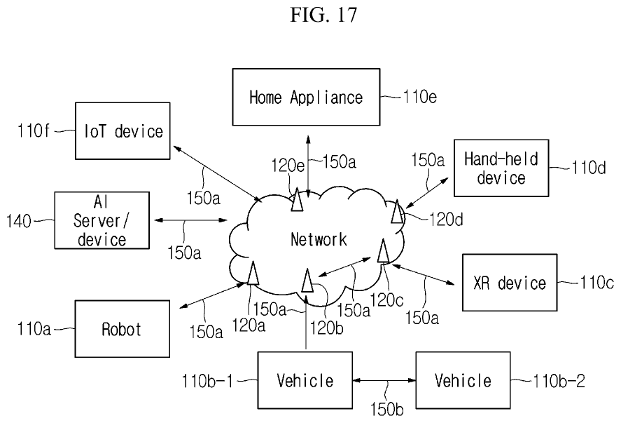

FIG. 17 illustrates an example of a communication system according to an embodiment of the present disclosure. The embodiment of FIG. 17 may be combined with various embodiments of the present disclosure.

Referring to FIG. 17, a communication system applied to the present disclosure includes a wireless device, a base station and a network. Here, the wireless device means a device for performing communication using radio access technology (e.g., 5G NR or LTE) and may be referred to as a communication/wireless/5G device. Although not limited thereto, the wireless device may include at least one of a robot 110a, vehicles 110b-1 and 110b-2, an extended reality (XR) device 110c, a hand-held device 110d, a home appliance 110e, an Internet of Thing (IoT) device 110f or an artificial intelligence (AI) device/server 110g. For example, the vehicle may include a vehicle having a wireless communication function, an autonomous vehicle, a vehicle capable of performing vehicle-to-vehicle communication or the like. Here, the vehicles 110b-1 and 110b-2 may include an unmanned aerial vehicle (UAV) (e.g., drone). The XR device 110c may include an augmented reality (AR)/virtual reality (VR)/mixed reality (MR) device and may be implemented in the form of a head-mounted device (HMD), a head-up display provided in a vehicle, a television, a smartphone, a computer, a wearable device, a home appliance, a digital signage, a vehicle, a robot, etc. The hand-held device 110d may include a smartphone, a smart pad, a wearable device (e.g., a smartwatch or smart glasses), a computer (e.g., a laptop, etc.), etc. The home appliance 110e may include a TV, a refrigerator, a washing machine, etc. The IoT device 110f may include a sensor, a smart meter, etc. For example, the base stations 120a to 120e and the network may be implemented by a wireless device, and the specific wireless device 120a may operate as a base station/network node for the other wireless devices.

Here, wireless communication technology implemented in the wireless devices 110a to 110f of this disclosure may include not only LTE, NR and 6G but also narrowband Internet of things for low-power communication. In this case, for example, NB-IoT technology may be an example of LPWAN (Low Power Wide Area Network) technology and may be implemented in the standard such as LTE Cat NB1 and/or LTE Cat NB2, without being limited to the above-described names. Additionally or alternatively, the wireless communication technology implemented in the wireless devices 110a to 110f of this disclosure may perform communication based on LTE-M technology. In this case, for example, the LTE-M technology may be an example of LPWAN technology, and may be referred to as various names such as eMTC (enhanced Machine Type Communication). For example, the LTE-M technology may be implemented in at least one of various standards such as 1) LTE CAT 0, 2) LTE Cat M1, 3) LTE Cat M2, 4) LTE non-BL(non-Bandwidth Limited), 5) LTE-MTC, 6) LTE Machine Type Communication, and/or 7) LTE M, without being limited to the above-described names. Additionally or alternatively, the wireless communication technology implemented in the wireless devices 110a to 110f of this disclosure may include at least one of ZigBee considering low-power communication, Bluetooth or low power wide area network (LPWAN), without being limited to the above-described names. For example, the ZigBee technology may generate personal area networks (PANs) related to small/low-power digital communication based on various standards such as IEEE 802.15.4 and may be referred to as various names.

The wireless devices 110a to 110f may be connected to the network through the base station 120a to 120e. AI technology is applicable to the wireless devices 110a to 110f, and the wireless devices 110a to 110f may be connected to the AI server 110g through the network. The network may be configured using a 3G network, a 4G (e.g., LTE) network, a 5G (e.g., NR) network, etc. The wireless devices 110a to 110f may communicate with each other through the base station 120a to 120e/network, or may perform direct communication (e.g., sidelink communication) without the base station 120a to 120e/network. For example, the vehicles 110b-1 and 110b-2 may perform direct communication (e.g., V2V (vehicle to vehicle)/V2X (vehicle to everything) communication). In addition, the IoT device 110f (e.g., a sensor) may perform direct communication with another IoT device (e.g., a sensor) or the other wireless devices 110a to 110f.

Wireless communication/connection 150a, 150b or 150c may be performed/established between the wireless devices 110a to 110f/base station 120a to 120e and the base station 120a to 120e/base station 120a to 120e. Here, wireless communication/connection may be performed/established through various radio access technologies (e.g., 5G NR) such as uplink/downlink communication 150a, sidelink communication 150b (or D2D communication) or BS-to-BS communication 150c (e.g., relay or integrated access backhaul (IAB)). The wireless device and the base station/wireless device or the base station and the base station may transmit/receive radio signals to/from each other through wireless communication/network 150a, 150b or 150c. For example, wireless communication/network 150a, 150b or 150c may enable signal transmission/reception through various physical channels. To this end, based on various proposes of the present disclosure, at least some of various configuration information setting processes for transmission/reception of radio signals, various signal processing procedures (e.g., channel encoding/decoding, modulation/demodulation, resource mapping/demapping, etc.) or resource allocation processes may be performed.

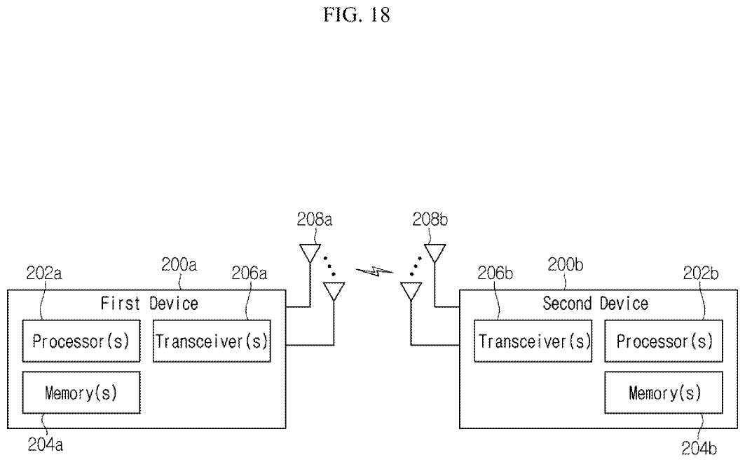

FIG. 18 illustrates an example of a wireless device according to an embodiment of the present disclosure.

Referring to FIG. 18, a first wireless device 200a and a second wireless device 200b may transmit/receive radio signals through various radio access technologies (e.g., LTE or NR). Here, {the first wireless device 200a and the second wireless device 200b} may correspond to {the wireless device 110x and the base station 120x} and/or {the wireless device 110x and the wireless device 110x} of FIG. 1.

The first wireless device 200a includes one or more processors 202a and one or more memories 204a and may further include one or more transceivers 206a and/or one or more antennas 208a. The processor 202a may be configured to control the memory 204a and/or the transceiver 206a and to implement the descriptions, functions, procedures, proposes, methods and/or operation flowcharts disclosed in the present disclosure. For example, the processor 202a may process information in the memory 204a to generate first information/signal and then transmit a radio signal including the first information/signal through the transceiver 206a. In addition, the processor 202a may receive a radio signal including second information/signal through the transceiver 206a and thus store information obtained from signal processing of the second information/signal in the memory 204a. The memory 204a may be connected to the processor 202a to store a variety of information related to operation of the processor 202a. For example, the memory 204a may perform some or all of the processes controlled by the processor 202a or store software code including commands for performing the descriptions, functions, procedures, proposes, methods and/or operation flowcharts disclosed in the present disclosure. Here, the processor 202a and the memory 204a may be a portion of a communication modem/circuit/chip designed to implement wireless communication technology (e.g., LTE or NR). The transceiver 206a may be connected to the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may mean a communication modem/circuit/chip.

The second wireless device 200b performs wireless communication with the first wireless device 200a, includes one or more processors 202b and one or more memories 204b and may further include one or more transceivers 206b and/or one or more antennas 208b. The functions of the one or more processors 202b, the one or more memories 204b, the one or more transceivers 206b and/or the one or more antennas 208b are similar to those of the one or more processors 202a, the one or more memories 204a, the one or more transceivers 206a and/or the one or more antennas 208a of the first wireless device 200a.

Hereinafter, the hardware elements of the wireless devices 200a and 200b will be described in greater detail. Although not limited thereto, one or more protocol layers may be implemented by one or more processors 202a and 202b. For example, the one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). The one or more processors 202a and 202b may generate one or more protocol data units (PDUs), one or more service data units (SDUs), messages, control information, data or information according to the descriptions, functions, procedures, proposes, methods and/or operation flowcharts disclosed in the present disclosure. The one or more processors 202a and 202b may generate and provide signals (e.g., baseband signals) including the PDUs, the SDUs, the messages, the control information, the data or the information to the one or more transceivers 206a and 206b according to the functions, procedures, proposes and/or methods disclosed in the present disclosure. The one or more processors 202a and 202b may receive signals (e.g., baseband signals) from one or more transceivers 206a and 206b to obtain the PDUs, the SDUs, the messages, the control information, the data or the information according to the descriptions, functions, procedures, proposes, methods and/or operation flowcharts disclosed in the present disclosure.

The one or more processors 202a and 202b may be referred to as controllers, microcontrollers or microcomputers. The one or more processors 202a and 202b may be implemented by hardware, firmware, software or a combination thereof. For example, one or more ASICs (application specific integrated circuits), one or more DSPs (digital signal processors), one or more DSPDs (digital signal processing devices), one or more PLDs (programmable logic devices) or one or more FPGAs (field programmable gate arrays) may be included in the one or more processors 202a and 202b. The descriptions, functions, procedures, proposes, methods and/or operation flowcharts disclosed in the present disclosure may be implemented using firmware or software, and the firmware or software may be implemented to include modules, procedures, functions, etc. The firmware or software configured to perform descriptions, functions, procedures, proposes, methods and/or operation flowcharts disclosed in the present disclosure may be included in the one or more processors 202a and 202b or stored in the one or more memories 204a and 204b and driven by the one or more processors 202a and 202b. The descriptions, functions, procedures, proposes, methods and/or operation flowcharts disclosed in the present disclosure may be implemented using firmware or software in the form of code, a command and/or a set of commands.

The one or more memories 204a and 204b may be connected to the one or more processors 202a and 202b to store various types of data, signals, messages, information, programs, code, instructions and/or commands. The one or more memories 204a and 204b may include a ROM (read only memory), a RAM (random access memory), an EPROM (erasable programmable read only memory), a flash memory, a hard drive, a register, a cache memory, a computer-readable storage medium and/or a combination thereof. The one or more memories 204a and 204b may be located inside and/or outside the one or more processors 202a and 202b. In addition, the one or more memories 204a and 204b may be connected to the one or more processors 202a and 202b through various technologies such as wired or wireless connection.

The one or more transceivers 206a and 206b may transmit, to one or more other devices, user data, control information, radio signals/channels, etc. described in the methods and/or operation flowcharts of the present disclosure. The one or more transceivers 206a and 206b may receive, from one or more other devices, user data, control information, radio signals/channels, etc. described in the descriptions, functions, procedures, proposes, methods and/or operation flowcharts disclosed in the present disclosure. In addition, the one or more transceivers 206a and 206b may be connected to the one or more antennas 208a and 208b and may be configured to transmit/receive user data, control information, radio signals/channels, etc. described in the descriptions, functions, procedures, proposes, methods and/or operation flowcharts disclosed in the present disclosure through the one or more antennas 208a and 208b. In the present disclosure, one or more antennas may be a plurality of physical antennas or a plurality of logical antennas (e.g., antenna ports). The one or more transceivers 206a and 206b may convert the received radio signals/channels, etc. from RF band signals to the baseband signals, in order to process the received user data, control information, radio signals/channels, etc. using the one or more processors 202a and 202b. The one or more transceivers 206a and 206b may convert the user data, control information, radio signals/channels, etc. processed using the one or more processors 202a and 202b from a baseband signal to an RF band signal. To this end, the one or more transceivers 206a and 206b may include an (analog) oscillator and/or a filter.

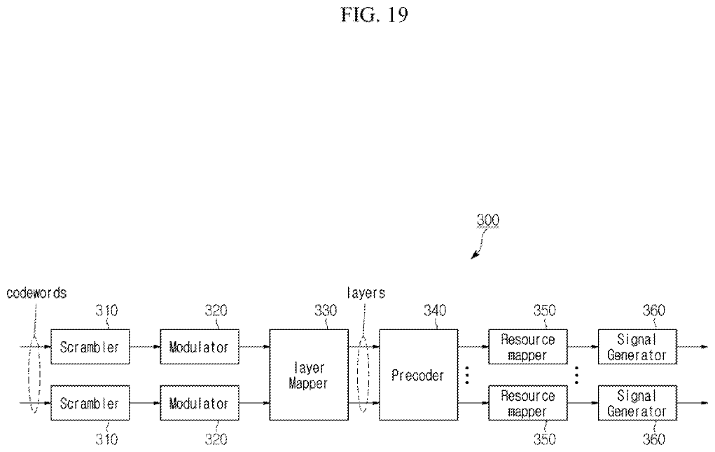

FIG. 19 illustrates a circuit for processing a transmitted signal according to an embodiment of the present disclosure. The embodiment of FIG. 19 may be combined with various embodiments of the present disclosure.

Referring to FIG. 19, a signal processing circuit 300 may include a scrambler 310, a modulator 320, a layer mapper 330, a precoder 340, a resource mapper 350 and a signal generator 360. In this case, for example, the operation/function of FIG. 19 may be performed by the processors 202a and 202b and/or the transceivers 206a and 206b of FIG. 18. In addition, for example, the hardware element of FIG. 19 may be implemented in the processors 202a and 202b and/or the transceivers 206a and 206b of FIG. 18. For example, blocks 310 to 360 may be implemented in the processors 202a and 202b of FIG. 18. Alternatively, the blocks 310 to 350 may be implemented in the processors 202a and 202b of FIG. 18 and the block 360 may be implemented in the transceivers 206a and 206b of FIG. 18, without being limited to the above-described embodiment.

The codeword may be converted into a radio signal through the signal processing circuit 300 of FIG. 19. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 19. Specifically, the codeword may be converted into a bit sequence scrambled by the scrambler 310. The scramble sequence used for scramble is generated based on an initialization value and the initialization value may be included in ID information, etc. of the wireless device. The scrambled bit sequence may be modulated to a modulation symbol sequency by the modulator 320. A modulation scheme may include pi/2-BPSK(pi/2-binary phase shift keying), m-PSK(m-phase shift keying), m-QAM(m-quadrature amplitude modulation), etc.

A complex modulation symbol sequence may be mapped to one or more transport layers by the layer mapper 330. The modulation symbols of each transport layer may be mapped to the corresponding antenna port(s) by the precoder 340 (precoding). The output z of the precoder 340 may be obtained by multiplying the output y of the layer mapper 330 by a N*M precoding matrix W. Here, N is the number of antenna ports and M is the number of transport layers. Here, the precoder 340 may perform precoding after performing transform precoding (e.g., discrete Fourier transform (DFT) with respect to complex modulation symbols. In addition, the precoder 340 may perform precoding without performing transform precoding.

The resource mapper 350 may map the modulation symbols of each antenna port to time-frequency resources. The time-frequency resources may include a plurality of symbols (e.g., CP-OFDMA symbols and DFT-s-OFDMA symbols) in the time domain and include a plurality of subcarriers in the frequency domain. The signal generator 360 may generate a radio signal from the mapped modulation symbols and transmit the generated radio signal to another device through each antenna. To this end, the signal generator 360 may include an inverse fast Fourier transform (IFFT) module and a cyclic prefix (CP) inserter, a digital-to-analog converter (DAC), a frequency uplink converter, etc.

A signal processing procedure for a received signal in a wireless device may be performed inversely to the signal processing procedure of FIG. 19. For example, the wireless device (e.g., 200a and 200b of FIG. 18) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover and a fast Fourier transform (FFT) module. Thereafter, the baseband signal may be restored to a codeword through a resource de-mapper processor, a postcoding processor, a demodulation process and a de-descramble process. The codeword may be restored to an original information block through decoding. Accordingly, a signal processing circuit (not shown) for the received signal may include a signal restorer, a resource de-mapper, a postcoder, a demodulator, a de-scrambler and a decoder.

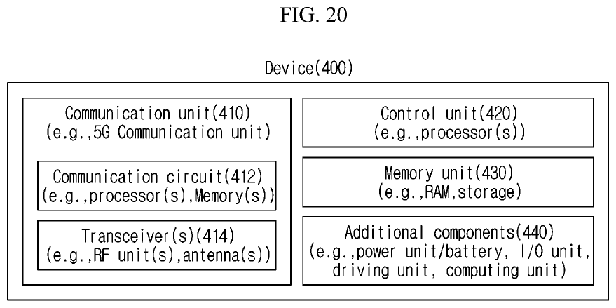

FIG. 20 illustrates another example of a wireless device according to an embodiment of the present disclosure. The embodiment of FIG. 20 may be combined with various embodiments of the present disclosure.

Referring to FIG. 20, the wireless device 300 corresponds to the wireless devices 200a and 200b of FIG. 18 and may include various elements, components, units and/or modules. For example, the wireless device 400 may include a communication unit 410, a control unit 420, a memory unit 430 and additional components 440.

The communication unit 410 may include a communication circuit 412 and transceiver(s) 414. The communication unit 410 may transmit and receive signals (e.g., data, control signals, etc.) to and from other wireless devices or base stations. For example, the communication circuit 412 may include the one or more processors 202a and 202b and/or the one or more memories 204a and 204b of FIG. 18. For example, the transceiver(s) 414 may include the one or more transceivers 206a and 206b and/or the one or more antennas 208a and 208b of FIG. 18.

The control unit 420 may consist of a set of one or more processors. For example, the control unit 420 may consist of a set of a communication control processor, an application processor (AP), an electronic control unit (ECU), a graphics processor and a memory control processor. The control unit 420 may be electrically connected to the communication unit 410, the memory unit 430 and the additional components 440 to control overall operation of the wireless device. For example, the control unit 420 may control electrical/mechanical operation of the wireless device based on the program/code/command/information stored in the memory unit 430. In addition, the control unit 420 may transmit the information stored in the memory unit 430 to the outside (e.g., another communication device) through the communication unit 410 using a wireless/wired interface or store, in the memory unit 430, the information received from the outside (e.g., another communication device) through the communication unit 410 using a wireless/wired interface.

The memory unit 430 may include a RAM, a DRAM (dynamic RAM), a ROM, a flash memory, a volatile memory, a non-volatile memory and/or a combination thereof. The memory unit 430 may store data/parameters/programs/code/commands necessary to drive the wireless device 400. In addition, the memory unit 430 may store input/output data/information, etc.

The additional components 440 may be variously configured according to the type of the wireless device. For example, the additional components 440 may include at least one of a power unit/battery, an input/output unit, a driving unit or a computing unit. Although not limited thereto, the wireless device 400 may be implemented in the form of a robot (FIG. 1, 110a), a vehicle (FIG. 1, 110b-1 and 110b-2), an XR device (FIG. 1, 110c), a hand-held device (FIG. 1, 110d), a home appliance (FIG. 1, 110e), an IoT device (FIG. 1, 110f), a digital broadcast user equipment, a hologram device, a public safety device, an MTC device, a medical device, a Fintech device (or a financial device), a security device, a climate/environment device, an AI server/device (FIG. 1, 140), or a network node. The wireless device is movable or may be used at a fixed place according to the use example/service.

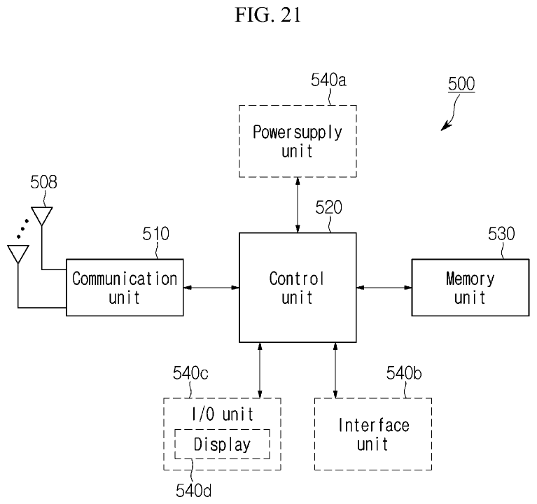

FIG. 21 illustrates an example of a hand-held device according to an embodiment of the present disclosure. FIG. 21 shows a hand-held device applied to the present disclosure. The hand-held device may include a smartphone, a smart pad, a wearable device (e.g., a smartwatch or smart glasses), a portable computer (e.g., a laptop), etc. The embodiment of FIG. 21 may be combined with various embodiments of the present disclosure.

Referring to FIG. 21, the hand-held device 500 may include an antenna unit 508, a communication unit 510, a control unit 530, a power supply unit 540a, an interface unit 540b and an input/output unit 540c. The antenna unit 508 may be a portion of the communication unit 510. Blocks 510 to 530/540a to 540c may respectively correspond to the blocks 410 to 430/440 of FIG. 20 and a repeated description thereof will be omitted.

The communication unit 510 may transmit and receive signals, the control unit 520 may control the hand-held device 500, and the memory unit 530 may store data, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output image video information/signals, audio information/signals, data and/or information received from a user. The input/output unit 540c may include a camera, a microphone, a user input unit, a display 540d, a speaker and/or a haptic module.

For example, in the case of data communication, the input/output unit 540c may obtain information/signals (e.g., touch, text, voice, image or video) received from the user and store the obtained information/signals in the memory unit 530. The communication unit 510 may convert the information/signals stored in the memory into radio signals and transmit the converted radio signals to another wireless device directly or to the base station. In addition, the communication unit 510 may receive the radio signals from another wireless device or the base station and then restore the received radio signals into original information/signals. The restored information/signals may be stored in the memory unit 530 and then output through the input/output unit 540c in various forms (e.g., text, voice, image, video or haptic).

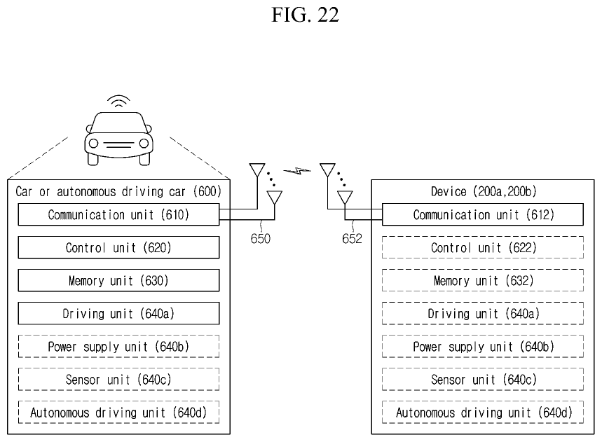

FIG. 22 illustrates an example of a vehicle or an autonomous vehicle according to an embodiment of the present disclosure. FIG. 22 shows a vehicle or an autonomous vehicle applied to the present disclosure. The vehicle or autonomous vehicle may be implemented by a mobile robot, a car, a train, a manned/unmanned Aerial Vehicle (AV), a ship, etc., but the shape of the vehicle is not limited. The embodiment of FIG. 22 may be combined with various embodiments of the present disclosure.

Referring to FIG. 22, a vehicle or autonomous vehicle 600 may include an antenna unit 608, a communication unit 610, a control unit 620, a driving unit 640a, a power supply unit 640b, a sensor unit 640c, and an autonomous driving unit 640d. The antenna unit 608 may be configured as a part of the communication unit 610. The blocks 610/630/640a-640d correspond to the blocks 510/530/540 of FIG. 21, respectively, and a repeated description thereof will be omitted.

The communication unit 610 may transmit and receive signals (e.g., data and control signals) to and from external devices such as other vehicles, BSs (e.g., gNBs and road side units), and servers. The control unit 620 may perform various operations by controlling elements of the vehicle or the autonomous vehicle 600. The control unit 620 may include an Electronic Control Unit (ECU). The driving unit 640a may cause the vehicle or the autonomous vehicle 600 to drive on a road. The driving unit 640a may include an engine, a motor, a powertrain, a wheel, a brake, a steering device, etc. The power supply unit 640b may supply power to the vehicle or the autonomous vehicle 600 and include a wired/wireless charging circuit, a battery, etc. The sensor unit 640c may obtain a vehicle state, ambient environment information, user information, etc. The sensor unit 640c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 640d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 610 may receive map data, traffic information data, etc., from an external server. The autonomous driving unit 640d may generate an autonomous driving path and a driving plan from the obtained data. The control unit 620 may control the driving unit 640a such that the vehicle or the autonomous vehicle 600 may move along the autonomous driving path according to the driving plan (e.g., speed/direction control). In the middle of autonomous driving, the communication unit 610 may aperiodically/periodically obtain recent traffic information data from the external server and obtain surrounding traffic information data from neighboring vehicles. In the middle of autonomous driving, the sensor unit 640c may obtain a vehicle state and/or surrounding environment information. The autonomous driving unit 640d may update the autonomous driving path and the driving plan based on the newly obtained data/information. The communication unit 610 may transfer information on a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

The embodiments of the present disclosure have the following effects.

According to the present disclosure, it is possible to efficiently maintain self-interference cancellation performance of a certain level or more in a UE performing full duplex radio (FDR) communication.

The effects of the present disclosure are not limited to the above-described effects and other effects which are not described herein may be derived by those skilled in the art from the description of the embodiments of the present disclosure. That is, effects which are not intended by the present disclosure may be derived by those skilled in the art from the embodiments of the present disclosure.

Since examples of the above-described proposed method may also be included as one of the implementation methods of the present disclosure, it is obvious that they may be regarded as a kind of proposed method. In addition, the above-described proposed methods may be implemented independently, but may be implemented in the form of a combination (or merge) of some of the proposed methods. The rule can be defined so that the base station informs the UE of information indicating whether the proposed methods are applicable (or information on the rules of the proposed methods) through a predefined signal (e.g., a physical layer signal or a higher layer signal).

The present disclosure may be embodied in other specific forms without departing from the technical idea and essential features described in the present disclosure. Therefore, the detailed description above should not be construed as restrictive in all respects and should be considered as illustrative. The scope of the present disclosure should be determined by reasonable interpretation of the appended claims, and all changes within the equivalent scope of the present disclosure are included in the scope of the present disclosure. In addition, the embodiments may be configured by combining claims that do not have an explicit citation relationship in the claims, or new claims may be included by amendment after the application is filed.

What is claimed is:

1. A method for performing, by a user equipment, measurement report in a wireless communication system, the method comprising:
receiving, by the user equipment, a measurement resource from a base station;
performing measurement based on the measurement resource; and
transmitting, based on a result of the performing, a measurement report comprising a measurement result to the base station,
wherein the measurement report comprises the measurement result and information indicating whether self-interference cancellation is successful.

2. The method of claim 1, wherein the user equipment operates based on at least one of full duplex radio (FDR) and half duplex radio (HDR).

3. The method of claim 2, wherein, when the user equipment performs communication with the base station based on FDR, the user equipment simultaneously performs uplink signal transmission and downlink signal reception in a single frequency band.

4. The method of claim 3, wherein the user equipment, which performs communication with the base station based on the FDR, performs a self-interference cancellation operation for the downlink signal reception.

5. The method of claim 1, wherein, when the information indicating whether or not self-interference cancellation is successful indicates success of self-interference cancellation, the base station executes at least one of a handover procedure and a beam recovery procedure based on the measurement report.

6. The method of claim 1, wherein, when the information indicating whether or not self-interference cancellation is successful indicates failure of self-interference cancellation, the base station changes configuration information for the user equipment and retransmit the measurement resource to the user equipment based on the changed configuration information.

7. The method of claim 6, wherein the configuration information comprises at least one of transmission power control information, duplex mode change information and resource re-allocation information.

8. The method of claim 1, wherein the measurement resource comprises at least one of a channel status information-reference signal (CSI-RS) and a synchronization signal block (SSB).

9. The method of claim 1, wherein the user equipment performs the measurement through the measurement resource based on at least one among received signal received power (RSRP), reference signal received quality (RSRQ), and signal to interference plus noise ratio (SINR).

10. The method of claim 9, wherein the measurement report comprises information on at least one of the RSRP, the RSRQ and the SINR and the information on whether or not self-interference cancellation is successful.

11. The method of claim 10, wherein the information on whether or not self-interference cancellation is successful is configured as one-bit information.

12. A user equipment configured to perform measurement report in a wireless communication system, the user equipment comprising:
a transceiver; and
a processor coupled to the transceiver,
wherein the processor is configured to:
receive a measurement resource from a base station via the transceiver,
perform measurement based on the measurement resource, and
transmit a measurement report comprising a measurement result to the base station based on a result of the performing,
wherein the measurement report comprises the measurement result and information indicating whether self-interference cancellation is successful.

13. A method for receiving, by a base station, a measurement report in a wireless communication system, the method comprising:
transmitting a measurement resource to a user equipment; and
receiving the measurement report comprising a result of measurement performed by the user equipment,
wherein the measurement report comprises the result of measurement and information indicating whether self-interference cancellation is successful.
